(19) United States
(12) Patent Application Publication
(10) Pub. No.: US 2026/0341752 A1
(43) Pub. Date: Oct. 29, 2026

(54) PORTABLE, MODULAR POWER GENERATING DEVICE

(71) Applicant: H2 PORTABLE POWER CORP., Rosedale (CA)

(72) Inventors: David Earl LEGER, Chilliwack, British Columbia (CA); Jacobus NEELS, Rosedale, british Columbia (CA); Tristan MILLER, Surrey, British Columbia (CA); Shane Carver BLACK, Agassiz, British Columbia (CA); Bruno Mathias BATE, Chilliwack, British Columbia (CA); Gary TEICHROB, Chilliwack, British Columbia (CA); Clark FRIESEN, Chilliwack, British Columbia (CA)

(21) Appl. No.: 19/103,999

(22) PCT Filed: Jul. 31, 2023
(86) PCT No.: PCT/CA2023/051027

§ 371 Date: Feb. 14, 2025

Related U.S. Application Data
(60) Provisional application No. 63/398,943, filed on Aug. 18, 2022.

(51) Int. Cl. H01M 8/04082; B60L 53/31; B60L 53/50; H01M 8/04014; H01M 8/04111; H01M 8/2404

(52) U.S. Cl. CPC H01M 8/04201; B60L 53/31; B60L 53/50; H01M 8/04014; H01M 8/04111; H01M 8/2404; H01M 2250/20

(57) ABSTRACT

A system for providing a resource using hydrogen gas or other combustible gas in some embodiments, the system includes a fuel module housing one or more compressed gas cylinders; a power module configured to receive gas from the fuel module and generate electrical power using said gas; and an application module configured to provide one or more useful outputs using said electrical power provided by the power module. The system can be mounted on a trailer. The application modules can be interchanged. The fuel module can include replaceable fuel cartridges, for example mounted on further trailers. The power module can include multiple physically separate air flow streams. A stackable and interchangeable system of modules, such as stackable fuel modules or stackable power module and fuel module, with standardized attachment footprints, is also provided.

### CROSS-REFERENCE TO RELATED APPLICATIONS

This application claims the benefit of priority to U.S. Provisional Patent Application No. 63/398,943, filed Aug. 18, 2022, the entire contents of which is hereby incorporated by reference.

### FIELD OF THE INVENTION

The present invention pertains to the field of portable power generation, and in particular to a portable, modular device which provides electrical or other type of power using hydrogen fuel cells or another means such as a hydrogen or other-fueled internal combustion engine.

### BACKGROUND

Portable power generation is a field currently dominated by diesel-powered electric generators. While common, these generators produce noise and harmful emissions. Many applications cannot allow for the noise, such as power generation for film sets. Situating the generators far from the set may not be possible or may require extensive cable runs.

Emissions are also a concern, especially in densely populated and/or indoor spaces. As well, the spilling of diesel fuel during refueling or use can be a concern, especially in environmentally sensitive areas. An additional consideration is that the engines used by diesel generators typically require service intervals that are much more frequent than similar electrical components.

Battery-powered portable power sources have been developed, solving some of the issues such as noise, emissions, service intervals, and environmental concerns regarding spilled fuel. However, the weight and limited power-density of batteries means they have either a limited capacity or are excessively large and heavy. This bulky size and/or low energy capacity, extended recharging times and need for a charging location significantly reduces the number of suited applications. In addition, current solutions have limited flexibility in their design and are not readily adaptable.

Therefore, there is a need for a portable power generating device that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a power generating device that is portable and modular, such as a hydrogen fuel-based device, or natural gas, methane or other lighter-than-air-fuel based device. The power may be generated with substantially zero greenhouse gas emissions. In various embodiments the power generating device is customizable, via its modularity, to any one of a variety of applications. Potential applications include but are not necessarily limited to battery charging, primary power generation, lighting, air compression, hydrogen gas refilling, and water purification.

According to embodiments of the present invention, there is provided a portable power generating device formed of multiple modules. Similarly, according to embodiments, there is provided a system of modules of different types, with different modules of a given type being interchangeable with one another, and the modules being configured so that they can be integrated together to form a portable power generating device. Capabilities of the device may be varied based at least in part on the particular modules of one or more types being used, particularly the application module.

In various embodiments, the types of modules include some or all of: a fuel module; a power module; an application module; one or more cooling and venting modules; and a mounting module. Some or all of the modules may have their own generally standardized enclosure geometries, configured so that the modules can be fitted together and be interchangeable.

According to embodiments, the fuel module is stackable on top of a second module, such as the power module, another suitable module, or a combination thereof. By providing the fuel module on top, potential risk due to leakage of lighter-than-air fuel such as hydrogen is mitigated. In some embodiments, the fuel module and the second module have a same, first type of attachment footprint associated with (e.g. on) their upper surfaces, which is configured for mating attachment with a second type of attachment footprint associated with the lower surface of the fuel module. In this way, the fuel module can be stacked onto the second module, or multiple fuel modules can be stacked on top of one another. This provides for a reconfigurable system of modules in different stacking configurations.

In some embodiments, the fuel module and the second module have the same, second type of attachment surface associated with their lower surfaces. Furthermore, an upper surface of the mounting module has the first type of attachment surface associated with its upper surface. In this way, either the fuel module (or more typically multiple, similar fuel modules) can be provided on the mounting module to provide a portable (e.g. trailerized) auxiliary fuel source or portable (e.g. trailerized) fuel delivery system, or the second module and the fuel module can be provided together on the mounting module to provide for a portable generator with onboard fuel.

Turning now to arrangements which may not necessarily include the stackability feature above, the fuel module may include, within its enclosure geometry, one or more (e.g. hydrogen, natural gas or methane) fuel storage containers, such as pressurized cylinders. In one such embodiment, such a storage container has a fuel outlet located at or proximate to the rear most portion of the fuel module and at a substantially furthest point from the power module, application module and transportation towing hitch. This can provide for improved safety with respect to potential storage container gaseous fuel leaks and associated ventilation solutions.

The power module may include, within its enclosure geometry, the components necessary to produce electricity when provided a reactant (e.g. hydrogen) and oxidant (e.g. oxygen) via a reaction other than a combustion reaction, e.g. via an electrochemical reaction. In certain embodiments, the power module may also include components for the distribution of electricity to one or more outlets which may be located at or near the end of the fuel module that is without hydrogen fuel outlets. The power module may alternatively include an internal combustion engine configured to generate kinetic energy by combustion of fuel. The kinetic energy may then be converted into electricity or another useful form of energy.

The application module may include, within its enclosure geometry, components necessary for receiving electricity from the power module and for providing one or more electrical or non-electrical power outputs or other useful functions using the electricity. In various embodiments, the application module may be configured to distribute electricity for a specific application, an example being a receptacle interface with industrial, commercial, or residential receptacles and/or electric vehicle and/or battery charging receptacles. As well, in some embodiments the application module may include the necessary components to convert electricity produced by the power module into illumination, useful work, or the like, or a combination thereof, some examples being an industrial compressor, reverse osmosis water purifier and high-pressure gas refueling dispenser. The application module may be configured to perform one or more tasks, such as those listed above. In various embodiments, the application module may also include air inlet and outlet vents.

The cooling and venting modules are configured, when integrated into the device, to receive and route gases, heat, or both, emitted from one or more other modules, such as the fuel module, power module, and application module. The emitted gases can include hydrogen or other lighter-than-air fuel gas emitted as the consequence of a leak. The cooling and venting modules may either circulate or eject the received gases, heat, or both, as is desirable for the safe and reliable operation of the overall device. A cooling and venting module may perform one or both of cooling and venting, for one or multiple other modules. In various embodiments, cooling and venting modules as described herein can also operate as heating modules, for example to provide adequate heat when operating in cold environments.

The mounting module may or may not incorporate or connect with a complimentary transport means, mounting systems, electrical systems, cooling systems and/or fueling systems for integration with one or more other components of the overall device's anatomy. The mounting module may operate as a platform for receiving and holding one, some or all of the other modules.

The transport means may provide the attachment or incorporation of the required components and systems to transport the overall device (i.e. the power providing unit) legally and safely from place to place and from time to time, as required by a user. Examples of the transport means may include a trailer mount chassis, a skid mount chassis, a powered-motive mount chassis, a barge mount chassis, an airlift mount chassis, a stationary mount chassis, or another chassis. In some embodiments, the transport means may have a hitch or other similar connection mechanism such that it may be towed or physically moved by a vehicle or other self-powered device. In certain embodiments, the hitch and towing vehicle may be located at the furthest point from the outlets of the (e.g. hydrogen) fuel storage containers. Thus, the (e.g. hydrogen) fuel outlets may be located at a rearmost point of the device, when the device is being transported.

In some embodiments of the invention, not all module types are used, multiple modules of the same type may be present, or both. In some embodiments the device is packaged such that some or all of the modules thereof are fixed and cannot be easily removed from each other. In other embodiments, one or more of the modules are configured for easy removal and replacement with a different module with identical or different characteristics, depending on operational requirements.

According to embodiments of the present invention, there is provided a system for providing a resource using lighter-than-air fuel such as hydrogen gas. The system includes a fuel module housing one or more compressed fuel (e.g. hydrogen gas) cylinders. The system includes a power module configured to receive fuel from the fuel module and generate electrical power using the fuel. The system includes an application module configured to provide one or more useful outputs using said electrical power provided by the power module.

Embodiments provide for a system for providing a resource using a combustible gas. The system includes a fuel module housing one or more compressed cylinders containing the combustible gas. The system includes a second one or more modules, such as a power module, configured to receive the combustible gas from the fuel module and generate electrical power using the combustible gas. The second one or more modules, for example an application module thereof, is configured, and to provide one or more useful outputs using the electrical power.

Embodiments provide for a power module for generating electricity using hydrogen gas. The power module is configured to cause two or more physically separate air flow streams therein. Each of the two or more physically separate air flow streams may provide component cooling, combustible gas venting, or a combination thereof, for a different respective portion of an interior of the power module. In some embodiments, a first one of the physically separate air flow streams has a higher potential for containing a portion of the combustible gas than a second one of the physically separate air flow streams, and this first one of the physically separate air flow streams is located above said second one of the physically separate air flow streams. The air flow streams can be directed generally upward. The air flow streams can be separated or configured so that they avoid flowing from potential sources of leaked combustible gas toward potential sources of combustion.

Turning now to arrangements which specifically include the stackability feature as mentioned above, embodiments provide a system for providing a resource using a combustible gas. The system includes a fuel module housing one or more compressed cylinders containing the combustible gas. The system includes a second module, such as a power module, or a combined power module and application module, configured to receive the combustible gas from the fuel module and generate electrical power using the combustible gas. The fuel module has, in association with an upper surface thereof, a first attachment footprint, the second module has, in association with an upper surface thereof, a second attachment footprint, and the fuel module has, in association with a lower surface thereof, a third attachment footprint. The first and second attachment footprint are configured for mating attachment with the third attachment footprint.

The system may further include a mounting module having, in association with an upper surface thereof, a fourth attachment footprint. The second module may then have, in association with a lower surface thereof, a fifth attachment footprint. The fourth attachment footprint is configured for mating attachment with the third attachment footprint and the fifth attachment footprint.

Embodiments may provide for methods in association with the apparatus and systems as described herein, such as methods of operation, methods of reconfiguring systems, or methods of providing such systems. For example, in one embodiment, there is provided a method involving: providing a plurality of interchangeable or reconfigurable modules; coupling the modules together to provide a desired system out of a plurality of possible systems that can be formed from a selection of such modules, or a both.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIGS. 1 to 6 illustrate, in various views, a portable power generating device, in accordance with some embodiments of the present invention.

FIG. 7 illustrates a rear view of a portable power generating device, including a gas cylinder layout, according to some embodiments.

FIG. 8 illustrates a stationary power generating device, or alternatively internal components of a portable power generating device, according to some embodiments.

FIG. 9 illustrates a power module with a single fuel cell unit, according to some embodiments.

FIG. 10 illustrates a power module with two fuel cell units, according to some embodiments.

FIGS. 11 to 12 illustrate a slide-out fuel cartridge for a power generating device, according to some embodiments.

FIG. 13 illustrates a fuel cartridge with a beveled shape, according to some embodiments.

FIGS. 14 and 15 illustrate an application module as a power distribution module, according to some embodiments.

FIG. 16 illustrates an application module as a power distribution module optimized for industrial or construction use, according to some embodiments.

FIG. 17 illustrates an application module as a power distribution module optimized for residential use, according to some embodiments.

FIG. 18 illustrates an application module as a gas compressor, according to some embodiments.

FIG. 19 illustrates an application module as a gas compressor and dispenser, according to some embodiments.

FIG. 20 illustrates an application module as a water purifier, according to some embodiments.

FIGS. 21 and 22 illustrate an application module as a retractable light tower, according to some embodiments.

FIGS. 23 and 24 illustrate an application module as a charging station, according to some embodiments.

FIGS. 25A and 25B illustrate a power module with multiple separate air flow streams, according to some embodiments.

FIG. 26 also illustrates a power module with multiple separate air flow streams, according to some embodiments.

FIG. 27 illustrates a vent cap of a power generating device, according to embodiments.

FIG. 28 illustrates a single-piece vent cap for a power generating device, according to embodiments.

FIGS. 29 to 32 illustrate a trailerized fuel cartridge and its association with a fuel module, according to some embodiments.

FIG. 33 illustrates a mounting module, according to some embodiments.

FIG. 34 illustrates a mounting module with fuel cartridge, according to some embodiments.

FIG. 35 illustrates a power module with fuel cell unit, according to some embodiments.

FIG. 36 illustrates a fuel cylinder layout for a removable fuel cartridge, according to some embodiments.

FIG. 37 illustrates a fuel cylinder cartridge with lifting connection points, according to an embodiment.

FIG. 38 illustrates a containerized power generating device or power module according to an embodiment.

FIGS. 39 and 40 illustrate a container including multiple containerized power generating devices or power modules according to an embodiment.

FIG. 41 illustrates a portable power generating device without onboard fuel, according to another embodiment.

FIG. 42 illustrates an exploded view of a portable power generating device having multiple stacked modules, according to an embodiment.

FIG. 43 illustrates the power generating device of FIG. 42 in assembled view.

FIG. 44 illustrates a mounting module for the power generating device of FIG. 42, according to an embodiment.

FIGS. 45A, 45B, 46 and 47 illustrate twist lock attachment devices for coupling modules of the power generating device of FIG. 42, according to an embodiment.

FIG. 48 illustrates a front view of the power generating device of FIG. 42, according to an embodiment.

FIG. 49 illustrates a power module, or module including the power module, of the power generating device of FIG. 42, according to an embodiment.

FIG. 50 illustrates a stationary power generating device having multiple stacked modules, according to an embodiment.

FIG. 51 illustrates an exploded view of a trailerized fuel delivery device having multiple stacked fuel modules, according to an embodiment.

FIG. 52 illustrates the fuel delivery device of FIG. 51 in assembled view.

FIG. 53 illustrates a stationary auxiliary fuel source having multiple stacked fuel modules, according to an embodiment.

It will be noted that throughout the appended drawings, like features are identified by like reference numerals.

### DETAILED DESCRIPTION

Unless defined otherwise, all technical and scientific terms used herein have the same meaning as commonly understood by one of ordinary skill in the art to which this invention belongs. The numbers and numbers combined with letters correspond to the component labels in all the figures.

Embodiments of the present invention relate to a system for converting lighter-than-air fuel such as hydrogen gas to a useful resource, such as but not necessarily including electricity. The system may be modular in nature, with the system being formable from assembling a plurality of modules of different types. Module types may include, for example, fuel module, power module, application module, cooling and venting module, and mounting module. The system may further be customizable by the use of different interchangeable modules of a same given type. For example, an application module may be removed and replaced with a different type of application module, in order to adapt the system to a different purpose. As another example, a fuel module, a power module, a cooling and venting module, a mounting module, or a combination thereof, may be readily removed and replaced with another similar or identical module. This allows for quick system repair, refueling, or the like. Modules may be readily separable from one another in some embodiments, e.g. coupled together by non-permanent devices. Functional couplings between modules, such as gas lines, ventilation ducts, electrical lines, and control wires, may be made via standardized interface types and locations. In other embodiments, the modules are substantially permanently coupled together at an initial manufacturing or deployment stage.

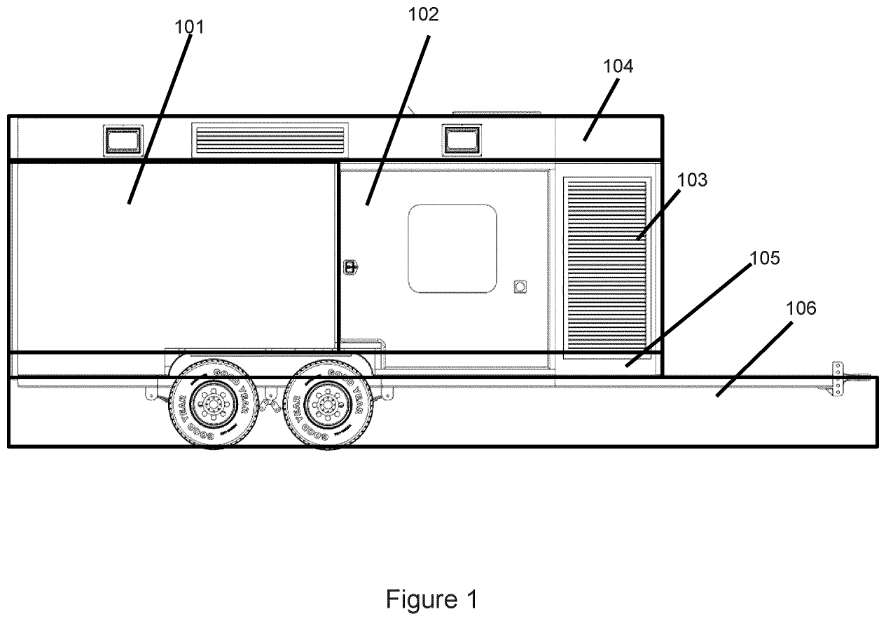

FIG. 1 illustrates a general layout of a portable power generating device, according to an embodiment of the present invention. The locations of various modular components of the device, including the fuel module 101, power module 102, application module 103, cooling and venting (cap) module 104, mounting module 105, and its associated transport means or portion 106, are illustrated.

The cooling and venting module 104 is operatively coupled to modules below it, such as the fuel module 101, power module 102, application module 103, or a combination thereof. It is configured to cause or facilitate air flow through such modules, for example by having powered fans which draw air upward. This forces air through the modules, for example by inducing one, two or more air flow streams in at least one of the modules. The fans and related ductwork can be aligned with vents at the tops of the respective fuel module 101, power module 102, and application module 103. Thus, air is drawn generally upward through these modules at one or more locations to be exhausted by the cooling and venting module 104.

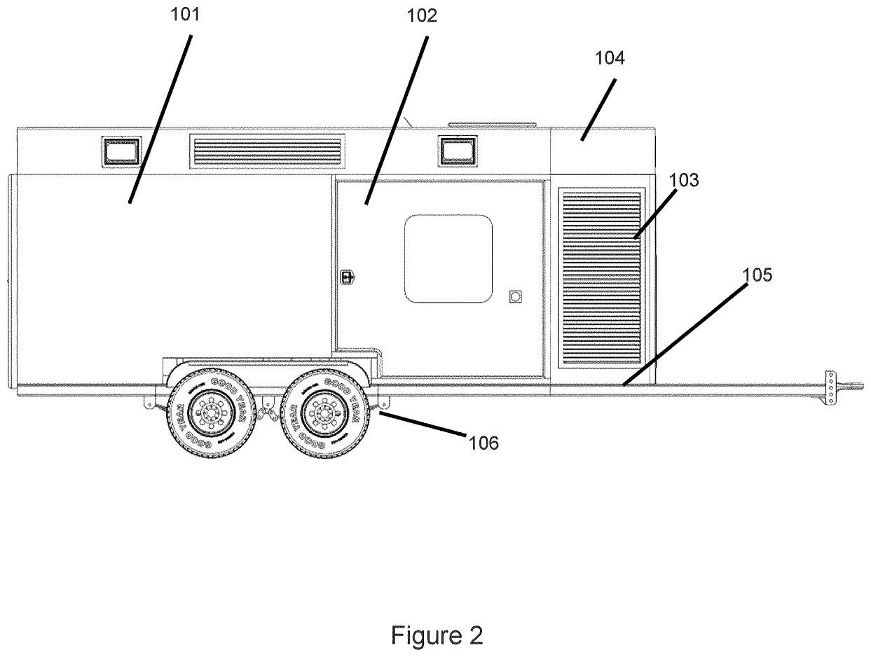

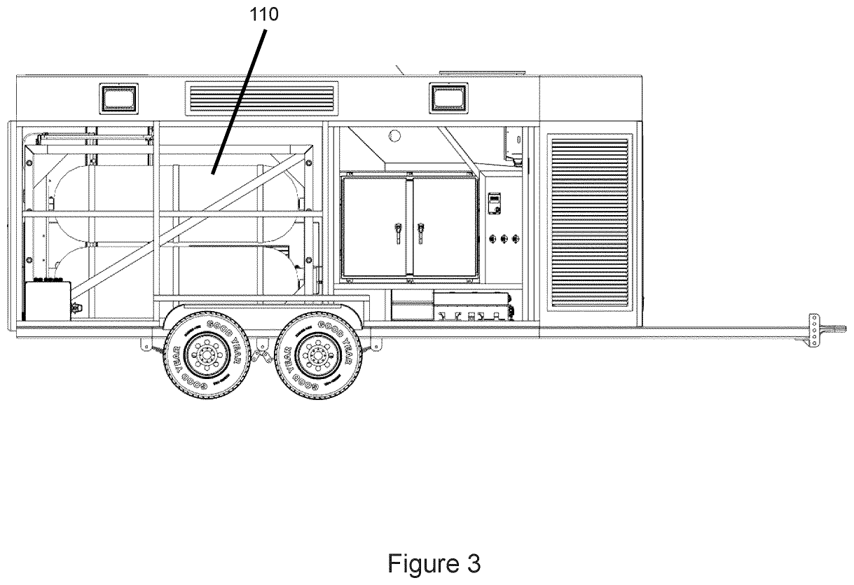

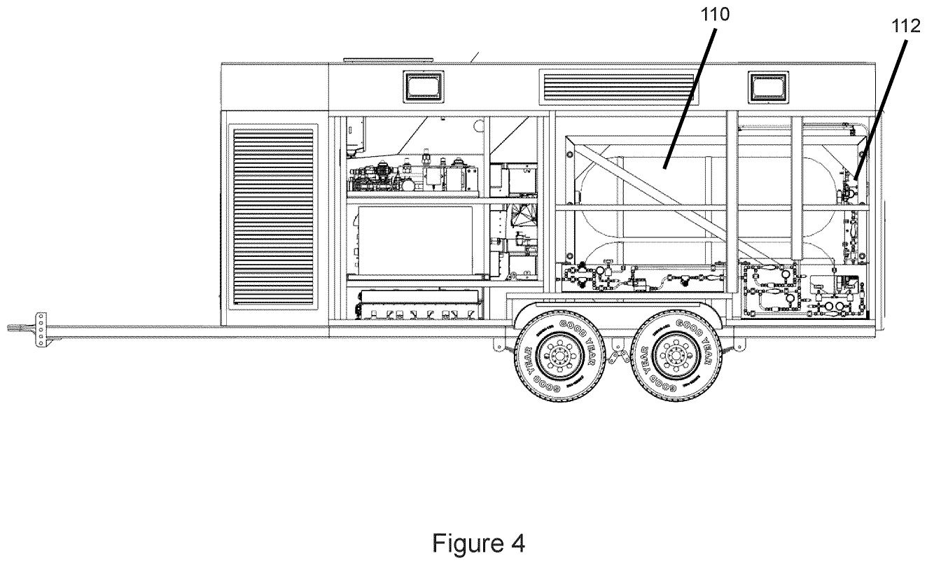

FIGS. 2 to 4 illustrate various side profiles of a portable power generating device, according to an embodiment of the present invention. Cylindrical fuel tanks 110 of the fuel module 101 are visible in FIGS. 3 to 4, where covers are absent. FIG. 4 illustrates gas outlets 112 of the fuel tanks 110 proximate to the rear of the device.

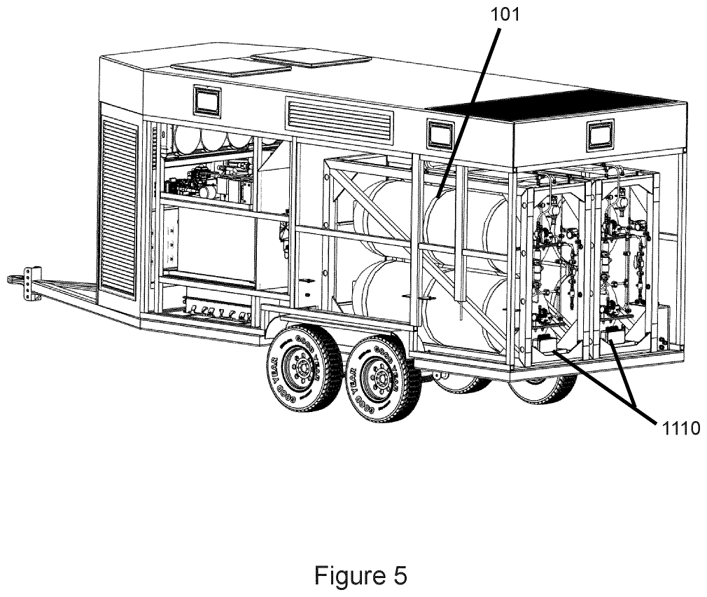

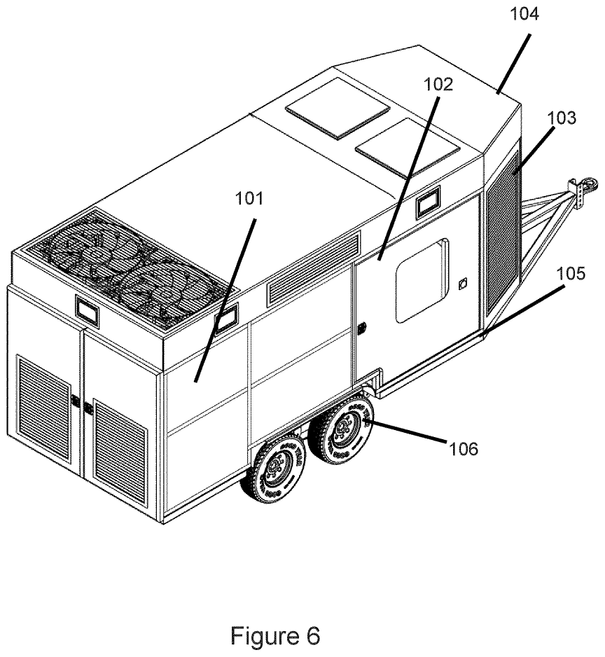

FIGS. 5 to 6 illustrate various additional views of a portable power generating device, with covers absent in FIG. 5, according to an embodiment of the present invention. FIG. 5 in particular illustrates the fuel module 101 including two removable and exchangeable fuel cartridges 1110.

The fuel module 101, also referred to as a hydrogen storage module (HSM) in some embodiments, potentially includes some or all the following features. The fuel module may include pressurized cylinders (e.g. filled with hydrogen or another lighter-than-air fuel or reactant) in various configurations and quantities, either mounted within the frame of the fuel module or mounted within one or more separate frames that mount within the frame of the fuel module. These frames may or may not be removable. In various embodiments the frames may be able to be removed, inserted, or exchanged from either the rear, sides, or top of the fuel module. The frames plus cylinders may compose (e.g. removable) cartridges. A cartridge which has been emptied of fuel (e.g. hydrogen gas) can be removed and replaced (exchanged) with another cartridge which has adequate fuel.

In certain embodiments, the fuel module may include a steam methane reformer, or similar device, capable of extracting useful hydrogen gas from a feedstock fuel. The fuel module may be configured to directly feed a fuel cell stack anode inlet with the hydrogen and/or store the extracted hydrogen for later use.

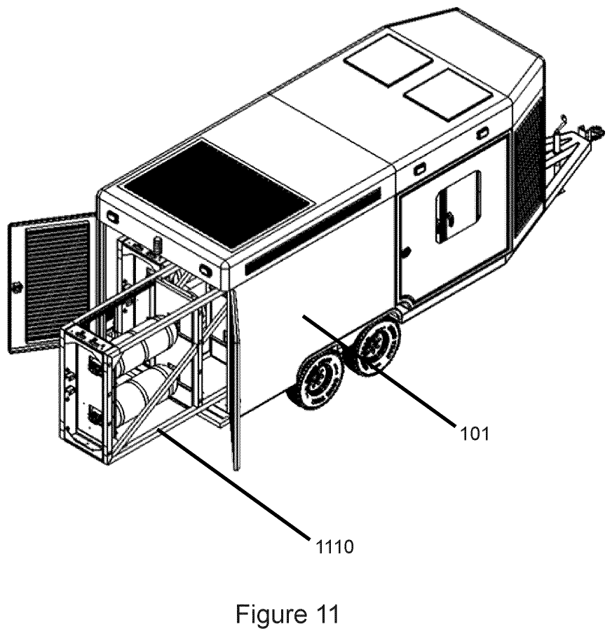

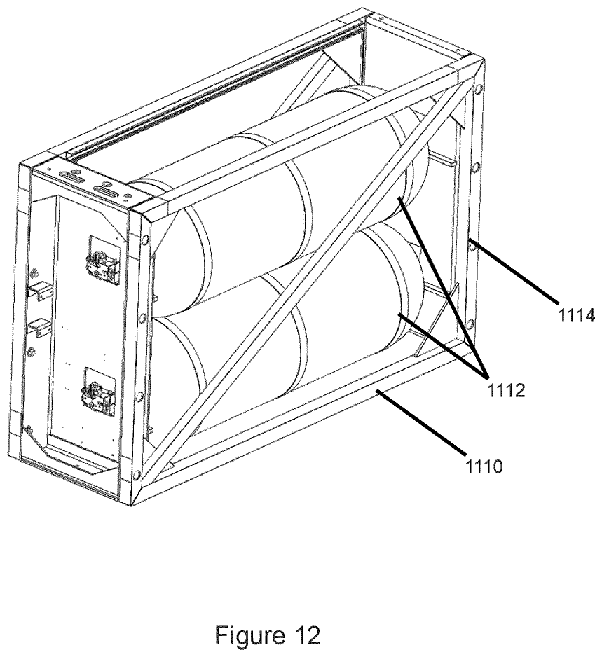

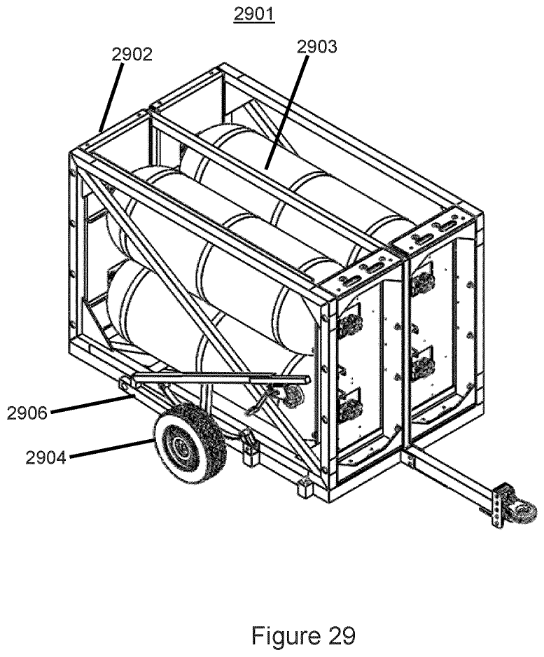

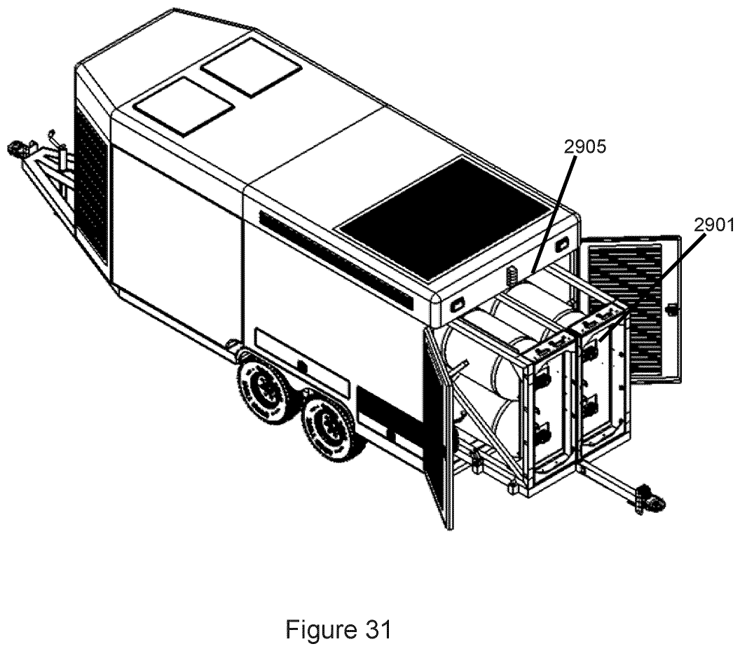

The fuel module exhibits several aspects, including an interior geometry that can accept an efficient nesting of cylinders, or cartridges containing one or more cylinders. In some embodiments, the fuel cylinder cartridges may utilize a guide, slide, and lock arrangement, or similar arrangement, to allow the cartridge to be slid out or removed completely from the fuel module. The fuel module itself may also use such an arrangement to slide out or be completely removed from the mounting module, as illustrated in more detail for example in FIG. 11. FIG. 11 shows a slide-out fuel cartridge 1110 partially removed from housing of the fuel module 101. FIG. 12 illustrates the cartridge 1110 in more detail, including cylinders 1112 mounted within an open-sided frame 1114. A similar trailerized cartridge is illustrated in FIGS. 29 to 32. Cartridges can thus be trailerized or non-trailerized.

Other modules, such as the power module, may also utilize a guide, slide, and lock arrangement, or similar arrangement, to slide out from or be removed completely from the mounting module. Such a guide, slide and lock mechanism, or a track-and-roller mechanism, or other similar mechanism for adding modules to or removing modules from the system may be included for one or more of the modules, as appropriate. The mounting module may include guides or rails for accommodating mating guides, rollers or rails of other modules, for example.

The fuel module and power module may or may not be connected directly to one another, with or without use of the mounting module. The fuel module may abut the power module and mate thereto via one or more physical, electrical, and/or gas conduit connectors. One or more connectors such as bolts or locking mechanisms may be used to secure the fuel module to the power module. Additionally or alternatively, connectors may secure the fuel module and the power module to the mounting module, so that the fuel module and the power module are (removably or non-removably) affixed to and supported by the mounting module.

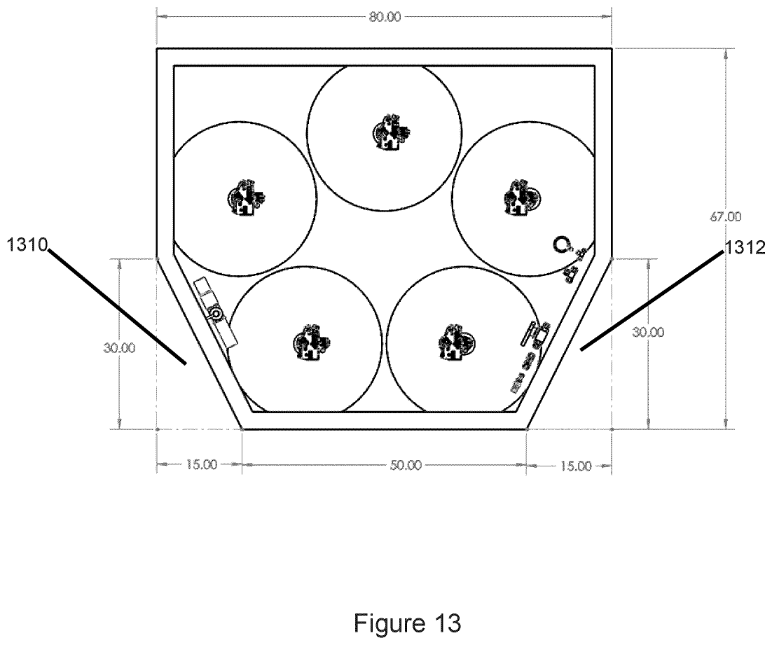

In certain embodiments, the cartridge geometry or fuel module geometry may be similar to that of standardized air cargo containers. A beveled bottom may be provided and may allow the cartridge or module to clear wheel wells (if included on the mounting module or transportation means) or other obstructions, accommodate a curved-wall storage area (such as a fuselage), or accommodate the slide, glide, and lock arrangement. The beveled bottom may also accommodate guide rails, or other cables or fuel lines utilizing the space. FIG. 13 illustrates an example of such a beveled bottom on a fuel cartridge.

In some embodiments, for example with reference to FIG. 13, electrical and fluid conduits are routed in the space provided by the beveled bottom sides 1310, 1312 of the cartridge or fuel module. Gas conduits may be routed on one side, e.g. under one beveled bottom side 1310, while electrical cables are routed on the opposite beveled bottom side, e.g. 1312. This separation of gas and electrical conduits may facilitate increased separation of the two component types and thus potentially increase safety, e.g. due to separation of potential ignition sources from combustible gas.

In some embodiments, single, multiple, or extended (increased size) fuel modules may be mounted on a same single mounting module. Such an arrangement can be used to maximize fuel volume on a single platform, or to create a mobile fueling station. Fuel modules may also be paired with a high-pressure hydrogen (or other type of) gas dispensing (HGD) application module. In such applications where power modules are potentially absent, the HGD application module may be powered externally such as by the grid, a generator, or the zero-emission power provider that is being filled.

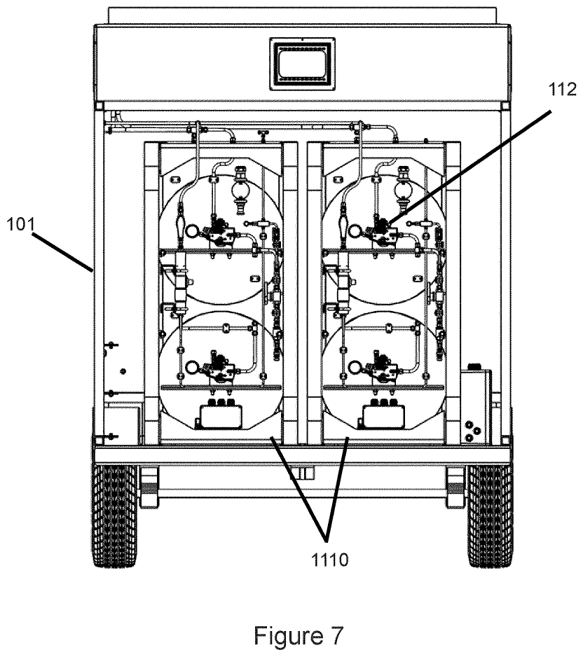

FIG. 7 is a rear view of a portable power generating device, according to an embodiment of the present invention. FIG. 7 further illustrates a potential layout of gas cylinders in a 2×2 rectangular configuration, with gas outlets 112 located proximate to the rear of the trailer-mounted device. The configuration may involve two side-by-side fuel cartridges 1110. In certain embodiments it may be desirable to place the fuel source and/or storage means outlets (the gas outlets 112) at or proximate to the rearmost portion of the fuel module and/or at the furthest point from the power module. As illustrated, these outlets are also at the rearmost portion of the portable power generating device overall. Such a configuration can provide for enhanced safety, with the valves being at the furthest point from the power module. Such a configuration can provide for simplified servicing due to ease of access to the outlets, fuel connection fittings, and possibly a regulator or distribution assembly coupled thereto.

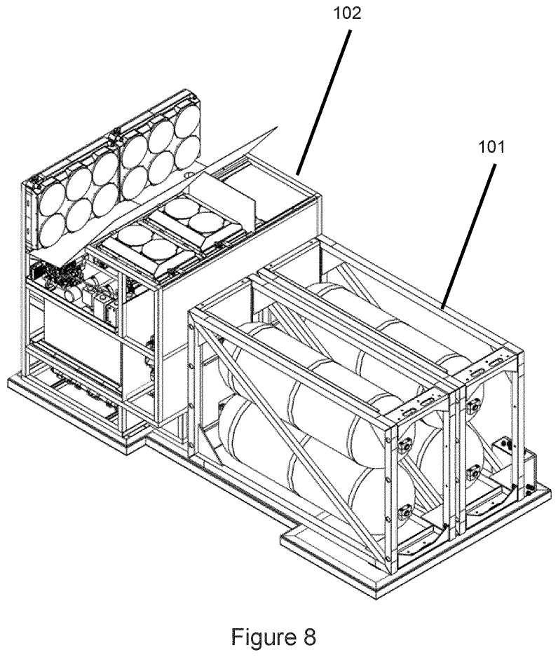

FIG. 8 illustrates a stationary embodiment of the present invention, including at least fuel module 101 and power module 102, with the transportation means or portion being absent. Covers are not shown.

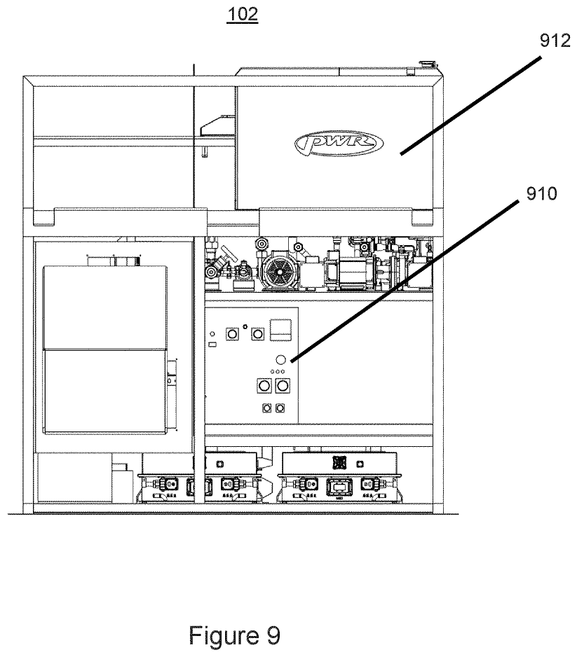

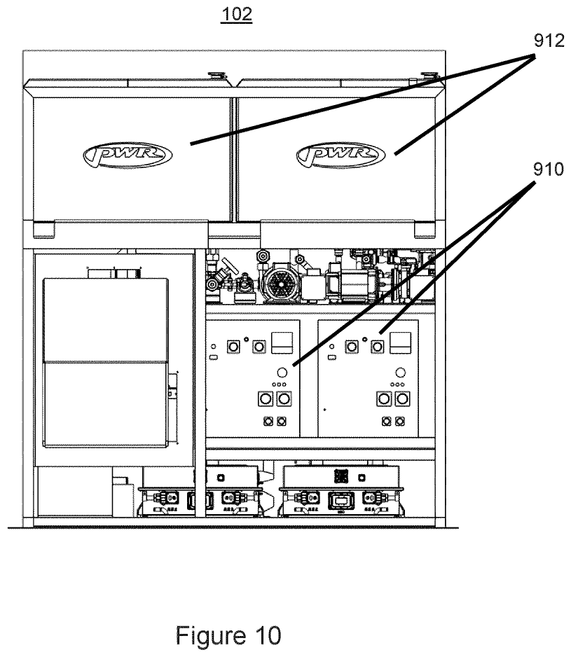

FIG. 9 illustrates a front view of a power module 102 having a single fuel cell unit 910 and associated heat exchanger 912, according to an embodiment. FIG. 10 illustrates a front view of a power module 102 having two fuel cell units 910 and associated heat exchangers 912, according to another embodiment.

### Application Module

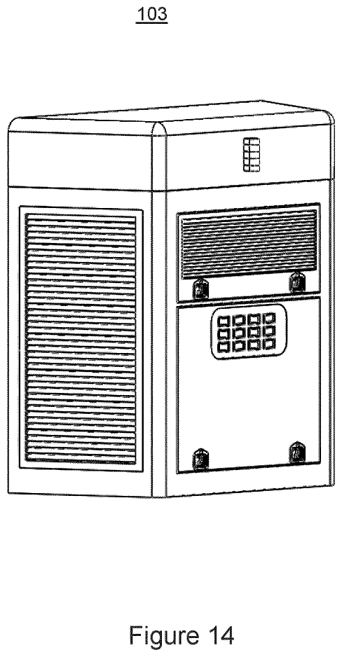

A variety of application modules, alternatively known as operator interface modules, can be selected and attached to a mounting module or otherwise accompany one or more fuel modules and/or power modules. In various embodiments, a system of interchangeable application modules is provided, each being configured for operative coupling to a power module. Each application module can have a same or similar physical layout and/or footprint to facilitate such interchanging, as well as a same or similar type of connectors, such as electrical connectors, for coupling to the power module. Examples of application modules are illustrated in FIGS. 14 to 24 and are described as follows. In various embodiments, for interchanging, one of the application modules is coupled to the power module at a time, while the others are decoupled from the power module.

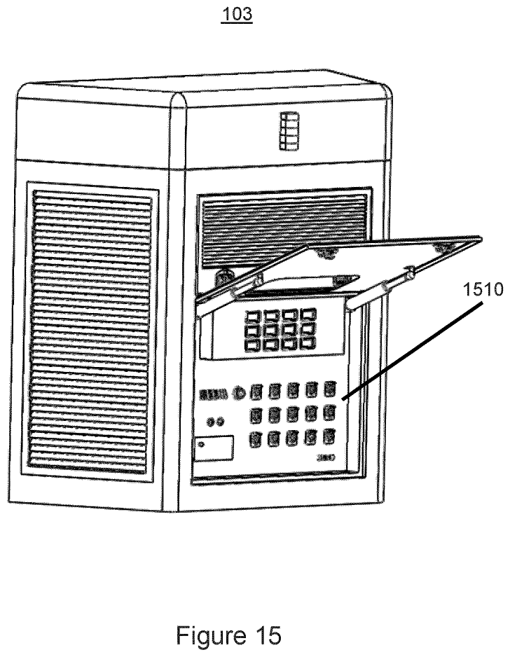

FIGS. 14 and 15 illustrate an application module 103 as a power distribution module optimized for powering TV and film sets, or other such events. A movable cover can cover various electrical outlets 1510 which provide suitable power for such events. The application module, and similar application modules such as those described below, can include suitable power transformers, inverters, breakers, meters, power conditioners, and the like, as would be readily understood by a worker skilled in the art. Alternatively, some or all of such components may be located in the power module. The application module may have communications protocol equipment (for example for facilitating communication between battery and charger for coordinated operation thereof), DC/DC converter, or the like. The application module (or power module, or a combination thereof) may include a coolant loop for cables and/or system components. The components can be configured and optimized for a certain application, for example to provide a suitable voltage, current, power quality, waveform, number of phases, and number of connectors.

When an application module is described as optimized for certain use, it may mean for example that the number of power outlets, and the voltage and amperage ratings, are designed for devices typically used in such applications. For example, a module optimized for residential use may include several 15-amp, 110-volt outlets.

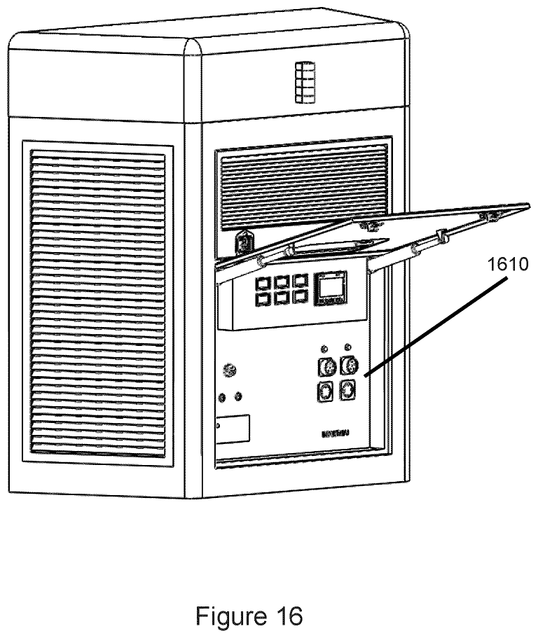

FIG. 16 illustrates an application module 103 as a power distribution module optimized for industrial and/or construction use. Electrical power is provided via outlets 1610.

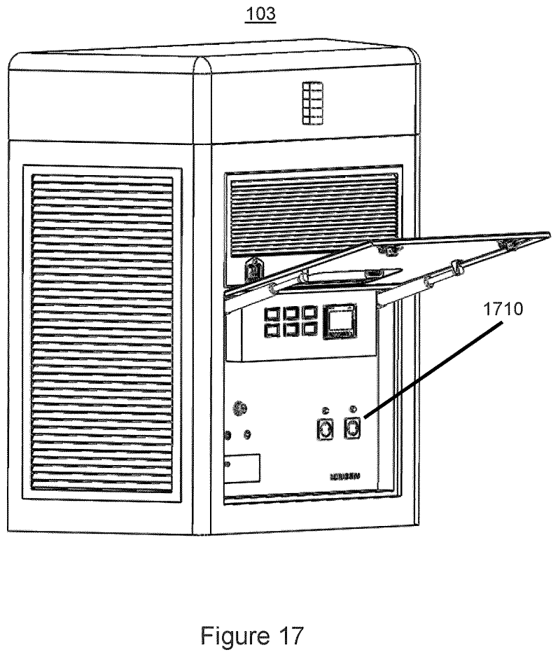

FIG. 17 illustrates an application module 103 as a power distribution module optimized for residential use. Electrical power is provided via outlets 1710.

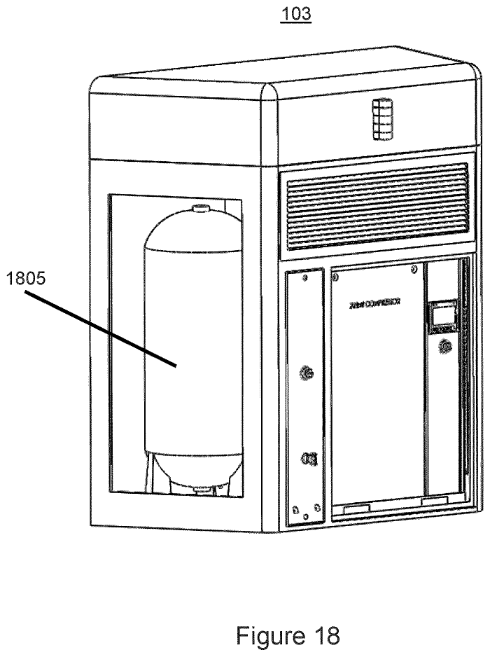

FIG. 18 illustrates an application module 103 as a residential or industrial gas (e.g. air) compressor module. The application module can include a compressed air storage tank 1805, one or more outlets, and an associated compressor, such as an air compressor commensurate with the output electrical capacity of the generator.

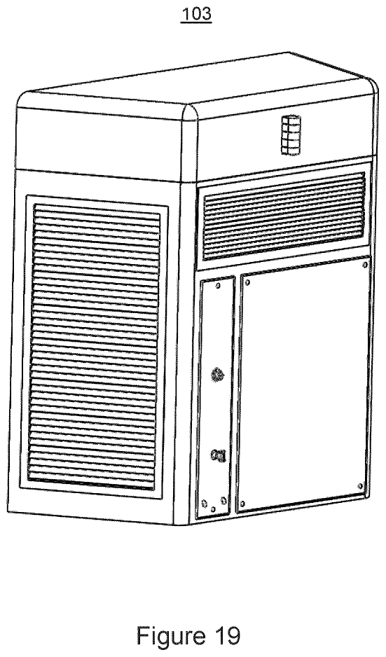

FIG. 19 illustrates an application module 103 as a gas compressor and dispensing module, possibly dispensing hydrogen or other gas or fluid, at, for example, 350 bar and/or 700 bar, via outlets. Hydrogen or other gas can be provided by the fuel module and pressure can be suitably converted and regulated as necessary by the application module. Power, if required, can be provided by the power module.

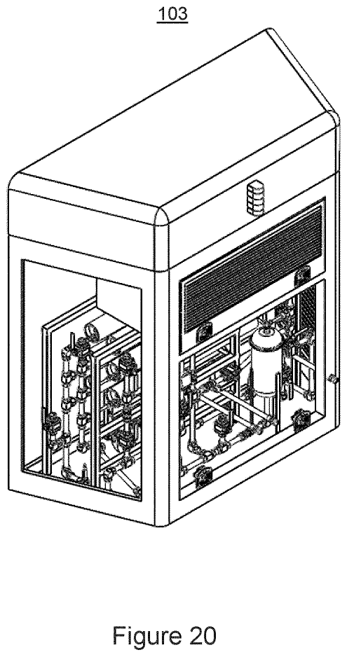

FIG. 20 illustrates an application module 103 as a (e.g. reverse osmosis) water purification module. A water purification system, including a water inlet and water outlet, and possible waste outlet, may be enclosed within the module and powered by the power module.

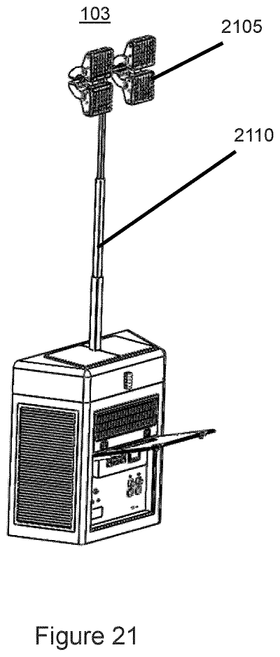

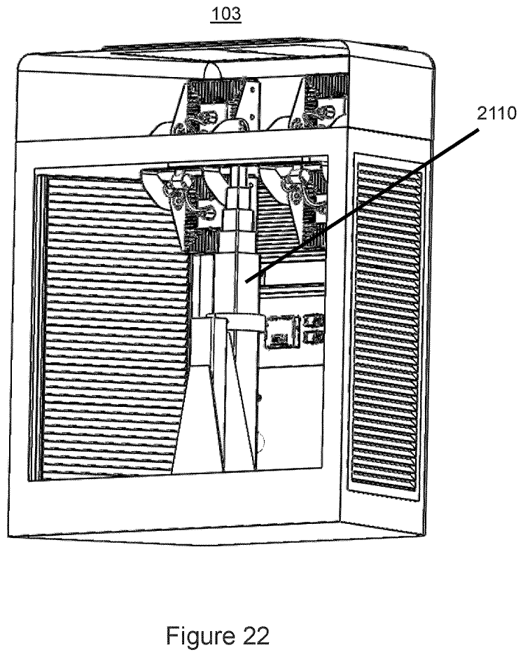

FIGS. 21-22 illustrate an application module 103 as a retractable light tower. In FIG. 21 a light source 2105, such as an LED lamp, is shown mounted at the top of a telescoping post 2110. In FIG. 22, the telescoping post 2110 is collapsed and stored along with the light source 2105 within the interior of the application module enclosure. Other variations can be implemented, for example part or all of the retractable post, part or all of the light source, or both, can be stored externally to the application module enclosure, for example resting on top thereof. Rather than a telescoping arrangement for the post, a folding or otherwise collapsible or assemble-able/disassemble-able post structure can be used.

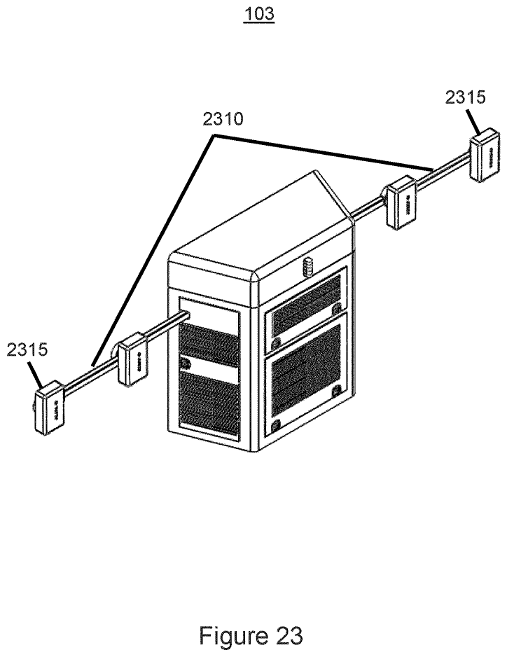

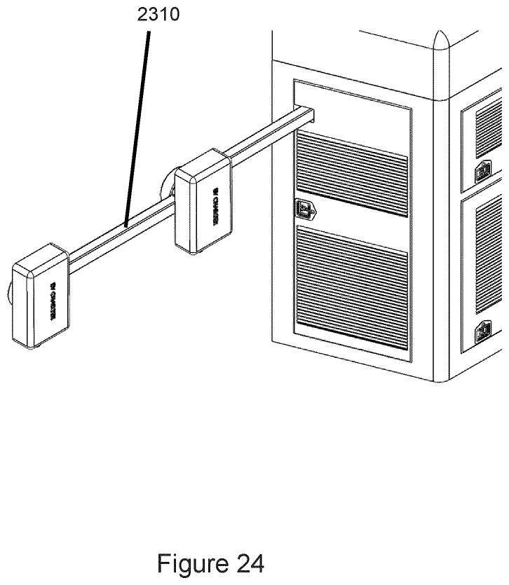

FIGS. 23-24 illustrate an application module 103 as a charging station, such as a dedicated level 2 or DC charging station, for charging electric vehicles, electric batteries, or similar devices. The charging station may include one or more articulating or extendable/retractable arms 2310 each having one or more charging ports 2315 mounted thereon. The application module may provide DC (or AC) power to the charging points at a level and with timing which is appropriate to charging of a given battery or other electrical energy storage device. The arms may fold or collapse for storage, and may potentially be disposed inside the application module enclosure when folded or collapsed.

In some embodiments, an application module configured as a charging station, as described in above, may have telescoping arms with one or more charging interfaces, allowing for multiple vehicles to park in front or alongside the portable power generator and charge simultaneously. In one such embodiment, the charging interfaces are distributed to accommodate four vehicles spaced typically when parked side-by-side in a row, such as in a parking lot.

In various embodiments, the application module may be configured to provide two or more functions. For example, the application module may be configured to provide a combination of two or more of: a light tower, power distribution, charging station, compressor module, work providing, air compressor, etc. The power distribution can be configured or optimized for one, two or more particular applications. A combination power distribution module and charging station may be provided. A combination power distribution and compressor module may be provided. Lights, telescoping posts, charging arms, etc. may be provided in the same application module. An application module may be configured on one side as a charging station, i.e. having one telescoping arm on one side as illustrated in FIG. 24, while the other side of the application module may be unused or configured in another manner for another application.

### Power Module and Airflow

In various embodiments, the power module layout is configured to provide at least one air flow stream that is functional in one or more ways, for example summarized as follows. Components such as the fuel cell stack, balance of plant (BoP), batteries, and other electrical components may be cooled by the air flow stream. Cooling may be achieved by direct forced convective cooling, or by indirect cooling of heat transfer media in a radiator, or both. The air flow stream may circulate air to other components, providing positive pressure (relative to other air flow streams, to inhibit flammable gas entry) in one or more locations where electrical components could cause ignition if combustible gas is present. The air flow stream may dilute and flush out pockets of accumulated hydrogen or other combustible lighter-than-air fuel gas, inhibiting or preventing combustion. Multiple, separate such air flow streams can be provided.

In some embodiments, to facilitate co-generation, The fuel cell cooling ventilation air or cooling water circuit may be used for heating of separate structures or may provide preheating for building utility systems increasing the overall thermal efficiency of the generator.

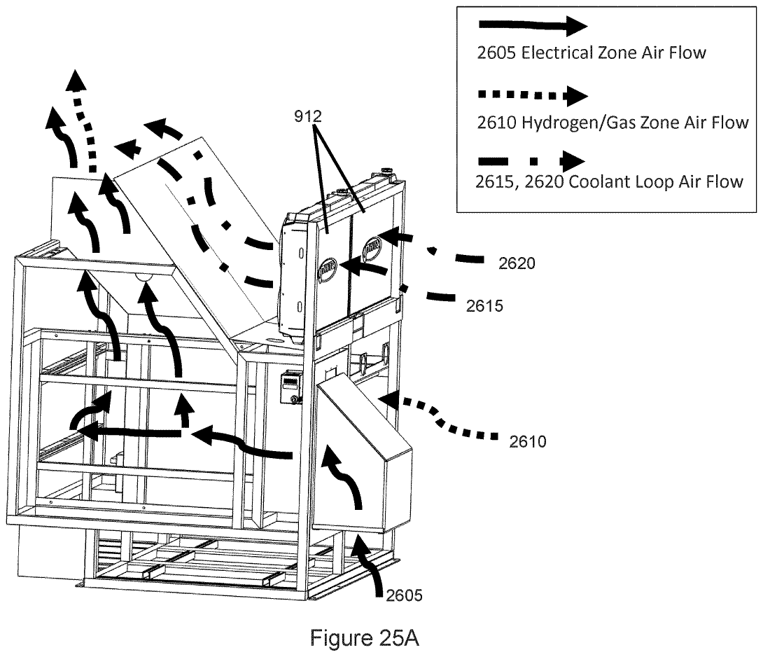

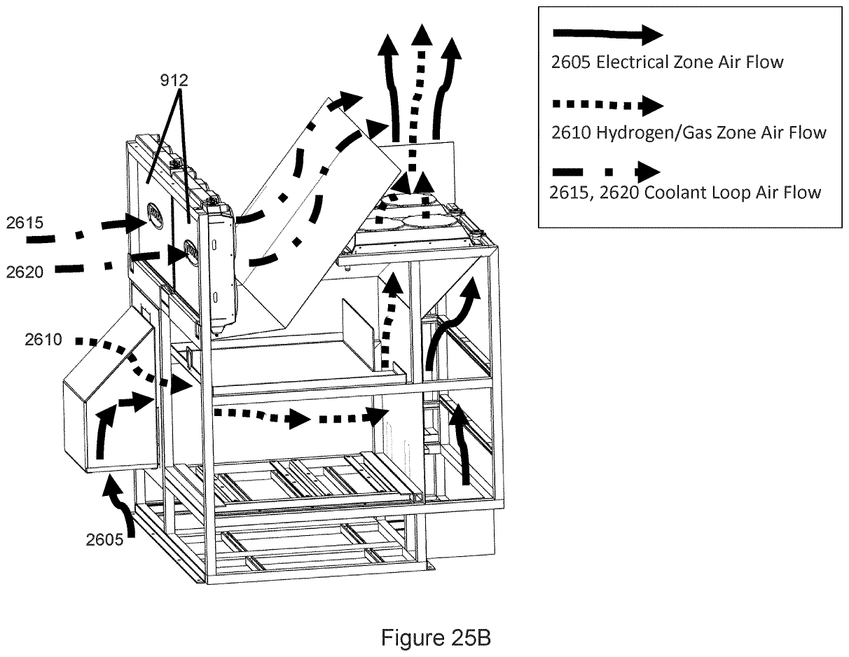

FIGS. 25A and 25B illustrate a power module and associated air flow stream(s) into, through and out from the power module's interior. The air flow stream(s) may be driven at least in part by fans of one or more cooling and venting modules. Air flow may be performed to serve one or more purposes, such as cooling of the power module's components, inhibiting the potential buildup of hazardous gases such as hydrogen (or methane, natural gas, or other gas), limiting flammable mixture zones by providing dilution of a (e.g. hydrogen) gas jet (from a fuel leak) in the event of a fuel component failure, and providing positive pressure from one compartment in the power module relative to other compartments, to inhibit flammable gas intrusion. Air may cool components by flowing directly over the components or over radiators (such as heat sinks) operatively coupled to the components. Alternatively, components may be cooled by an intermediate circulating fluid such as a liquid, and the intermediate fluid may be cooled by air flowing over an associated radiator.

Components of the power module cooled in the above manner can include batteries, electrical components, balance of plant (BoP) components, and fuel cell components, and radiators associated with such components.

In various embodiments, multiple physically separated air flow streams can be established through the power module. The air flow streams can be separated for example to inhibit air which potentially includes explosive content such as hydrogen or other gas from flowing past potential initiators of combustion, such as electrical components. Separating of air flow streams can balance cooling action amongst different components by avoiding or reducing the heating of air due to cooling some components prior to that air being used to cool other components. That is, different air flow streams can be parallelized so that they operate on different respective and separated portions of the power module interior. Different air flow streams can be physically separated for example by using barriers, ducts, fans, or the like, or a combination thereof. Different air flow streams can be confined to different spatial regions of the power module. Air inlets to the power module are physically separated from openings in the fuel storage module, to mitigate hydrogen (or other gas) contaminated air being drawn in via the inlets. As illustrated, air in each air flow stream is directed generally upward and toward the rear of the power module, to be exhausted from the top of the power module, or from a side of the power module. Air may be received from the front, side or bottom of the power module at one of a variety of inlet locations. One, some or all of the air flow streams may be driven by fans or other air forcing means. Other air flow streams may be passive, convective air flow streams in some embodiments. Different air flow streams typically have different air outlets but alternatively they may share a same air outlet. Different air flow streams may share a same air inlet or they may have different air inlets.

Two or more of the different air flow streams may be arranged in a side-by-side manner, with one of the air flow streams being located on or toward one side of the power module and another one of the air flow streams being located on or toward an opposite side of the power module. An air flow stream may similarly be located in a center region of the power module. An air flow stream located on a given side of the power module may have its air inlet and air outlets on that side, and all air may flow through spaces and over components on that side. Additionally or alternatively, two or more of the different air flow streams may be arranged in a top and bottom manner, with one of the air flow streams being located below another one of the air flow streams. The bottom air flow stream may have an air inlet below the air inlet for the top air flow stream, and the bottom air flow stream may have an air outlet generally behind the air outlet for the top air flow stream. The bottom air flow stream may flow through spaces and over components which are below and/or behind components and spaces subjected to the top air flow stream. An air flow stream potentially containing hydrogen or other gas can be situated above one or more other air flow streams potentially containing sources of combustion. An air flow stream potentially containing hydrogen or other gas can be situated above one or more components potentially acting as sources of combustion. This can mitigate combustion hazards due to the tendency of leaked hydrogen or other gas to rise. Different air flow streams may be at positive or negative pressure from one another to control air and hydrogen or other gas leakage direction, for example from one compartment or stream to another. In some embodiments, this also provides a means for detecting when compartment cross-flow is reversed, which can be used to trigger a shutdown to inhibit unsafe operations. For example, an air flow stream having potential sources of combustion may be at a higher pressure than an air flow stream potentially containing combustible gas.

FIGS. 25A and 25B illustrate, in particular, left and right views of a power module with air flows, according to an embodiment. Illustrated is an electrical zone air flow 2605 in which air enters an intake at a bottom, front left hand side of the power module and flows toward an exit at the rear, top left hand side of the power module. The electrical zone air flow 2605 flows past electrical components, such as batteries and power conditioning components. Also illustrated is a hydrogen/gas zone air flow 2610 in which air enters at a bottom, front right hand side of the power module and flows toward an exit at the rear, top right hand side of the power module. The hydrogen/gas zone air flow 2610 flows past components which handle combustible gas, such as hydrogen fuel cells generating electricity from hydrogen. Also illustrated are coolant loop air flows 2615, 2620 (which may be merged into one air flow). The coolant loop air flows enter at a top front of the power module and flow toward exits at the front, top of the power module. The coolant loop air flows 2615, 2620 may flow past at least heat exchangers 912 which are operatively coupled to fuel cells. Baffles or barriers may separate the three air flows from one another, as shown. The electrical zone airflow may extend rearward of the hydrogen/gas zone air flow. Notably, the hydrogen/gas zone airflow and/or coolant loop air flow(s) are separated from sources of ignition. Also, the coolant loop air flow(s), which potentially contain hydrogen gas, are above the sources of ignition of the electrical zone. In some embodiments, the coolant loop air flow(s) do not contain any significant sources of ignition, and thus can be safely placed above the hydrogen/gas zone air flow.

For example, the electrical zone air flow 2605 may flow past components which include potential sources of ignition, whereas the hydrogen/gas zone air flow 2610 may flow past components which are potential sources of leaked combustible gas. For example, fuel cells may be in the hydrogen/gas zone through which the flow 2610 passes, and power conditioning components and batteries may be in the electrical zone through which the flow 2605 passes. The two air flows 2605 and 2610 are separated laterally, but the air flow 2610 could be located above the air flow 2605 for additional guarding against exposure of combustible gas to ignition sources. The generally upward direction of the airflows and the upward exhausting of such airflows also mitigates the potential for combustible gas to infiltrate the electrical zone air flow. For example, the hydrogen/gas zone air flow 2610 is exhausted upward at the top of the module, which makes it unlikely for lighter-than-air gas to enter the electrical zone against the electrical zone air flow 2605. The coolant loop air flow 2615, 2620 may flow past heat exchanges such as those used to convey heat away from a hydrogen fuel cell reaction.

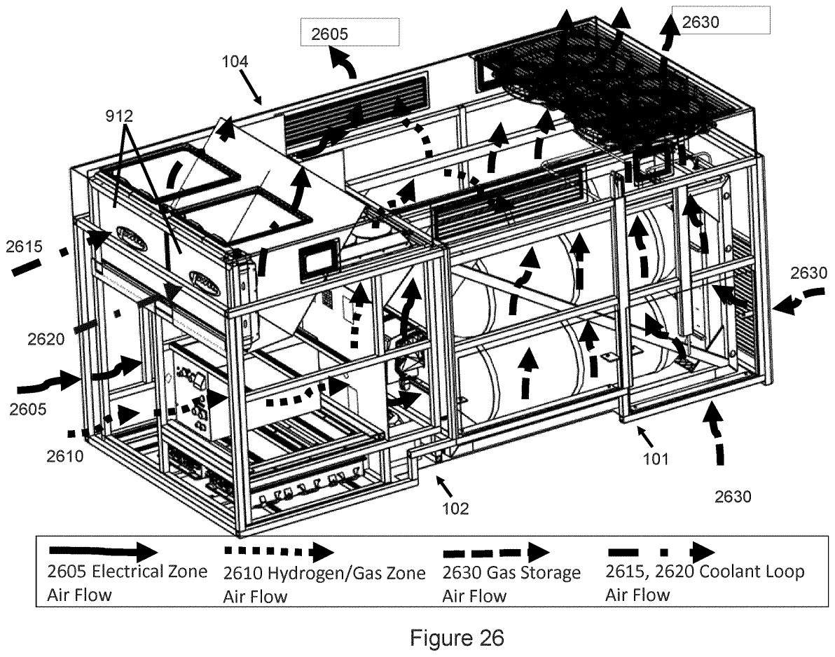

FIG. 26 illustrates another embodiment of a power module 102, cooling and venting module 104 and fuel module 101 with air flows. As illustrated by way of example in FIG. 26, a first air flow stream 2605 (electrical zone air flow stream) begins at an air inlet at the bottom, left portion of a front face of the power module and ends at an air outlet at the rear, left portion of a top face of the power module. A cooling and venting module 104 may receive air from the air outlet and expel this received air from a side vent. The first air flow stream flows over components situated in a bottom, left section of the power module. These components may include electrical components of the power module, batteries, or the like. Air flowing through air inlets at the front face of the power module may flow through an application module which is situated adjacent to this front face. The application module may include ducts or apertures to facilitate air being available to these air inlets.

A second air flow stream 2610 (hydrogen/gas zone air flow) begins at an air inlet at the bottom, right portion of the front face of the power module and ends at an air outlet at the rear, central or right portion of the top face of the power module 102. The cooling and venting module 104 may receive air from the air outlet and expel this received air from one or more side vents. The second air flow stream flows over components situated in a bottom right section of the power module. These components may include fuel cells of the power module, radiators of the power module, or the like.

A third air flow stream 2615 (coolant loop air flow) begins at an air inlet at the top, left portion of the front face of the power module and ends at an air outlet at the front, left portion of the top face of the power module 102. The cooling and venting module 104 may receive air from the air outlet and expel this received air from an associated top vent. The third air flow stream flows over components situated in a top left section of the power module. These components may include radiators of one or more of the power module's fuel cells.

A fourth air flow stream 2620 (coolant loop air flow) may also be present, which begins at an air inlet at the top, right portion of the front face of the power module and ends at an air outlet at the front, right portion of the top face of the power module 102. The cooling and venting module 104 may receive air from the air outlet and expel this received air from an associated top vent. The fourth air flow stream flows over components situated in a top right section of the power module. These components may include radiators of another one or more of the power module's fuel cells.

In some embodiments, the third and fourth air flow streams 2615, 2620 are merged into one air flow stream. Intermixing of the two air flow streams may occur.

Also illustrated in FIG. 26 is an air flow stream 2630 for a fuel module. The air flow stream for the fuel module is physically separate from all air flow streams of the power module. The air flow stream for the fuel module may begin at an air inlet at the bottom and/or rear of the fuel module and end at an air outlet at the top of the fuel module 101 and/or an associated cooling and venting module 104.

Also referring to FIG. 26, zones associated with air flow streams 2605, 2615, 2620 may have positive pressure relative to zones associated with air flow stream 2610. Zones associated with the air flow stream 2610 are more likely to include hydrogen (or other combustible) gas due to leaks, compared to zones in blue. A radiator heat exhaust (or heat exchange) zone at the top of the apparatus is shown in white, while the area associated with air flow stream 2630 is the (e.g. hydrogen) fuel storage zone. The different air flows 2605, 2610, 2615, 2620, 2630 are separated, with the possible exception that air flows 2615 and 2620 might not be separated. There is no air flow above the gas storage air flow 2630, in order to mitigate potential leaked gas from the fuel module entering another air flow. The electrical zone air flow 2605 is not above any of the other air flows, in order to mitigate leaked lighter-than-air gas entering the electrical zone air flow where it may flow past ignition sources. All of the air flows are directed generally (e.g. vertically or diagonally) upward, so that lighter-than-air combustible gas is more readily vented. Th coolant loop air flows 2615, 2620 are situated above at least the electrical zone air flow to mitigate the potential for leaked lighter-than-air gas (from coolant loop air flows 2615, 2620) to infiltrate other air flows such as the electrical zone air flow.

Hydrogen gas sensors (detectors), or other combustible gas sensors may be located within the power module at locations exposed to some or all of the air flow streams. These gas detectors may be placed and configured to detect leaking or accumulated combustible gas such as hydrogen. Temperature sensors may also be located within the power module. Operation of one or more of the modules, volumes of air flow streams, or both, can be adjusted, begun, prevented or ceased based on readings of such sensors. For example, detecting gas above a certain level may trigger an emergency shutdown procedure, alarm, or both. As another example, as discussed elsewhere herein, operations can be prevented or allowed based on outcome of a leak test conducted prior to start of power generation.

As mentioned above, locating of components potentially leaking combustible (e.g. hydrogen) gas in certain upper air flow streams, or in upper portions of certain air flow streams, may mitigate hazards associated with such leaks, as the combustible gas will typically rise upward. That is, components potentially leaking hazardous, lighter-than-air gases such as hydrogen may be situated in an upper part of the power module and in communication with one or more of the upper air flow streams, e.g. the third and fourth air flow streams. The lower air flow streams, e.g. the first and second air flow streams, may pass over components which have little or no potential to leak such gases. In this way, the potential to leak lighter-than-air gases from one air flow stream to another air flow stream is mitigated.

In some embodiments, a fan is used to provide cooling of a BoP heat exchanger and batteries. This fan may be configured, via air flow stream arrangements, to pull air from the fuel cell unit interior, providing a flow of air and exhausting it at the top of the power module. This same fan (or a different fan, or both) may turn on when triggered by a hydrogen or other combustible gas detector, such as may be triggered by a hydrogen or other combustible gas leak from the fuel cell unit or gas line connecting to it. Alternatively, the fan may be configured to remain on when hydrogen or other combustible gas is flowing from the fuel module, to inhibit undesired gas accumulation.

In some embodiments, the power module is configured to integrate with one or more adjacent modules (e.g. the fuel module and application module) to provide such other modules with the benefit of cooling, fresh air. The integration of zones (e.g. NFPA 497-classified zones or other defined zones involving air flows and differentiated for example using air pressure) between modules (for example by providing one or multiple air flows which involve one or more modules and/or which intermix) may be configured to comply with desired or required codes and regulations that address compressed gases, flammable gases and materials, the transportation of such gases, ignition sources, electrical panels and wiring, and other relevant safety concerns. This may make it practical to use general-purpose electrical components, potentially reducing cost and complexity while complying with applicable regulations.

To make the fuel module interior non-classified for abnormal conditions may require large, forced ventilation air flow streams, for example of about 3.53 m³/s (7600 CFM). Such large air flow streams may not be practical for portable implementations. In various embodiments, the forced ventilation is configured to provide an amount of air flow which maintains the gas concentration below a certain threshold (e.g. about 25% of LFL) even when two gas components (e.g. gas cylinders) have a SAE O ring failure. To guard against larger leaks or vent fan failures, gas detectors may be used. One, two or more gas detectors may be used. A controller may be configured initiate shut down of the generator and isolation of the gas in the fuel cylinder (e.g. by valve closure) upon the gas detectors detecting over a predetermined level of gas. A continuous running fan may be used to provide adequate ventilation when the generator is operating. For example, four fans may be used with each having a flow rate of about 0.33 m³/s (725 CFM), thus providing a total flow rate of about 1.32 m³/s (2900 CFM). Due to the relatively small compartment volume of the fuel module interior, this example arrangement may provide for over 1000 air changes per hour.

The fuel module compartment interior may be configured with louvers on the end wall and side walls, in the floor, or a combination thereof. The roof may also be provided with a large ventilation opening to reduce the likelihood of gas accumulation. Fans may be mounted above the fuel module and create high local ventilation velocities for diluting combustible gas leaks. Certain portions of the device may also have an inlet louver to promote natural ventilation upward into the fuel module interior. Gas from a leak will rise upward, e.g. to the top of the fuel module compartment where it can escape from the roof openings. The ventilation fans may facilitate movement of air/gas and inhibit accumulation of gas. In some embodiments, such a leak may arise in a part of the device, e.g. at the bottom of the fuel module compartment, which operates to refuel storage module cartridges or providing a regulated fuel supply to the power module. Such parts of the device may also have emergency shut-off valves.

In some embodiments, the power module is divided into multiple areas that are created as positive pressure zones, combustible gas (e.g. hydrogen) low pressure zones, and heat exchange sections. Such zones and sections are provided with inlet and outlet sections that allow for system cooling and sound attenuation. FIGS. 25A, 25B and 26 illustrate examples of such air flow streams. Area classification calculations may be performed during design in accordance with IEC standard for potential release conditions during normal and abnormal operation, and the power module may be designed accordingly. For example, the power module may be configured such that, under both normal operating and abnormal conditions, the power module is non-classified. In FIGS. 25A and 25B there are two coolant component assemblies/heat exchangers for supporting two fuel cell units, while in FIG. 26 there is one fuel cell unit and one coolant component assembly.

In various embodiments, the power module's fans are turned on prior to opening the fuel shutoff valves and remain on whenever the generator is operating. To guard against a large leak, a controller is configured to shut down the generator if gas levels in the fuel cell compartment (of the power module) exceed a certain threshold (e.g. about 10% of the lower flammability limit (LFL)). In some embodiments, during abnormal ventilation with the radiator fans failed, a standard leak from the fuel cell unit is adequately diluted by the natural draft and the area within the power module is non-classified. This arrangement may be based for example on the indoor flow velocities of 0.05 m/s as per the IEC calculations. With a valve/fitting leak the ventilation flow rate (e.g. about 160 CFM) is adequate to keep the FCU compartment non-classified based on the IEC calculations. Thus, natural (unforced) air flow, compartmentalization, vent size and placement, etc. may be configured so that the power module interior remains non-classified even when fans are not running and a standard combustible (e.g. hydrogen) gas leak occurs.

In various embodiments, the fuel cell unit enclosure is configured so that the combustible (e.g. hydrogen) gas level at the power module's ventilation outlet is below a certain threshold, e.g. about 10% of LFL. Accordingly, even with one failed fan and a gas leak, the fuel module compartment is non-hazardous. In the case of a cracked fuel cell plate, the ventilation air from the fuel cell unit will release 50% of LFL air into the fuel cell unit enclosure. The fuel cell unit enclosure refers to an enclosure within the power module, which encompasses the fuel cell stacks and fuel cell balance of plant. Gas detectors may be provided within the fuel cell unit enclosure. Assuming two fuel cells fail at the same time, the continuous operation of the two radiator fans at a minimum flow of 160 CFM each provide adequate dilution, and the area is non-classified. The cathode exhaust is mixed in with the radiator air stream downstream of the radiators. A gas sensor may be configured to cause a fuel cell operational shutdown at 75% of LFL (in air) in the event of combustible gas (e.g. hydrogen) leaking into the cathode side of the fuel cell. With the oxygen concentration at 10-11%, the dilution with the radiator air may be configured to reduce the levels of combustible gas to 25% of LFL.

In some embodiments, during abnormal operation, in the event of SAE O-ring seal leaks from gas fittings, and with mechanical ventilation, the area within the fuel module is classified as zone 2 hazardous (for example as per NFPA 497, described elsewhere herein). The average combustible gas concentration in the fuel module area may remain below 25% of LFL. A local zone 2 area of 0.8 m extends from the leak area. Because this is a relatively large area compared to the enclosure's size, the complete enclosure is rated as zone 2. The localized zone 2 does not necessarily extend past the outlet louvers, based on the average concentration always remaining below 25%. Air leaving the fan will be well-mixed and always below the LFL. If gas levels exceed 10% of LFL, the gas valves may be triggered to automatically close to stop the leak.

It is considered to be unlikely that a gas leak will extend passed the inlet louvers. If a gas leak occurs from a fitting close to the inlet louver, the jet of leaking gas will be contacting the louver and the jet will be spreading into a lower pressure release covering a larger area. Calculation of a low-pressure leak confirms that the inlet louver air entry velocity exceeds or is in the same order as the combustible gas (e.g. hydrogen) release velocity. The combustible gas is considered unlikely to escape from the inlet louver. When the generator is shut down, the gas is isolated in the fuel cylinders. In some embodiments, there are only two threaded connections to the cylinder that use an O-Ring for sealing. Leakage from these connections may result in gas levels higher than 25% of LFL based the IEC low indoor ventilation rates. Fans may still be operating if a combustible gas level greater than 10% is detected, provided battery power is available. The probability that these connections leak is very low. Such connections are used on many if not all compressed natural gas (CNG) and hydrogen gas fuel tanks and Transport Canada (TC) approved cylinders or U.S. department of transportation (DOT) approved cylinders, for example.

In various embodiments, leak tests are conducted prior to starting the generator. Leak tests are considered important to ensure that there are no gas leaks when the generator is put into service. Before the generator is started gas levels are checked and if above a threshold level (e.g. 10% of LFL) the generator is not started. Such a check may be performed automatically and gas sensors may be integrated with generator controls for this purpose. A relief valve release from the fuel supply line to the fuel cell is considered abnormal operation (equipment failure). The release is vented outside the fuel module trailer enclosure, located on the roof and the vent pointed vertically up. A pressure transmitter may be configured to shut down all gas valves on the cylinders and upstream and downstream of the regulator if the set pressure is exceeded. This pressure transmitter may be a differential pressure transmitter that measures the pressure of air within the electrical zone of the PCM relative to the outside or ambient air pressure to facilitate the space being a positive pressure zone. This mitigates the ingress of hydrogen or other combustible gas from the adjacent fuel cell unit zone. In the event of a regulator failure the low-pressure discharge from the regulator may increase and the pressure may exceed the pressure set point. Gas trapped between the upstream and downstream solenoid valves will then release from the relief valve. The amount of such released gas is expected to be small and the release is expected to be of short duration. For the calculation, the gas leak is considered a secondary release. In the event of a release there is vertical release of hydrogen or other combustible gas with a “zone 2” of a given size, for example 5.56 m.

For reference, and as an example, the standards document from the National Fire Protection Association (NFPA), numbered as NFPA 497 and entitled “Recommended Practice for the Classification of Flammable Liquids, Gases, or Vapors and of Hazardous (Classified) Locations for Electrical Installations in Chemical Process Areas” defines various zones as follows. Zone 0 is an area in which an explosive atmosphere is present continuously for long periods of time or will frequently occur. Zone 1 is an area in which an explosive atmosphere is likely to occur occasionally in normal operation. It may exist because of repair, maintenance operations, or leakage. Zone 2 is a place in which an explosive atmosphere is not likely to occur in normal operation but, if it does occur, will persist for a short period only. These areas only become hazardous in case of an accident or some unusual operating condition.

In various embodiments, electrical and ignition sources are located in higher-pressure and/or physically lower areas, to mitigate the possibility of combustible (e.g. hydrogen) gas reaching such sources. As a result, areas with conditions characterized as “zone 1” are avoided, and only secondary release is present. Secondary release is typically due to a minor leak as a result of a repair, maintenance rather than a system rupture or an open atmospheric valve release. The zone shape (above the apparatus) may be a conical shape extending upwards from the vent tube. That is, gas may be exhausted vertically upward from a top of the overall apparatus, and the zone may be conical in shape, the cone extending vertically and centered on the vent, which exhausts gas vertically upward. With wind the zone may be distorted sideways but for hydrogen, which is a very light gas, flow downwards is not expected. The potential for power module electrical compartment to draw in hydrogen is considered unlikely. The inlet louvers are a distance away and below the roof level. In various embodiments, it is considered important that the generator is not operated underneath canopies or enclosures so as to prevent accumulation of combustible gas.

### Further Details

In various embodiments, a vent cap module is provided and located overtop of some or all of the power, fuel, and application modules to accommodate and further route the flowing air. The vent cap may include one or more powered fans for moving air. The vent cap typically includes one or more cavities or openings for receiving air from one of the other modules and expelling the air outward from the system, e.g. out the top and/or sides of the vent cap. In various embodiments, the vent cap is simple to remove with equipment via provided lifting points, such as ISO corners. That is, the vent cap may include two or more connection points to which lifting equipment can be attached. The vent cap can be attached to another module using the ISO corners and an appropriate fastener, such as a twist lock.

In some embodiments, the vent cap is separable into two or more pieces as required. The vent cap, such as each of its separate pieces, may be attached to one or more other parts of the system, such as other accompanying modules. In some embodiments, the pieces of the vent cap are such that, when the other modules to which these vent cap pieces are assembled, the vent cap module is also accordingly assembled.

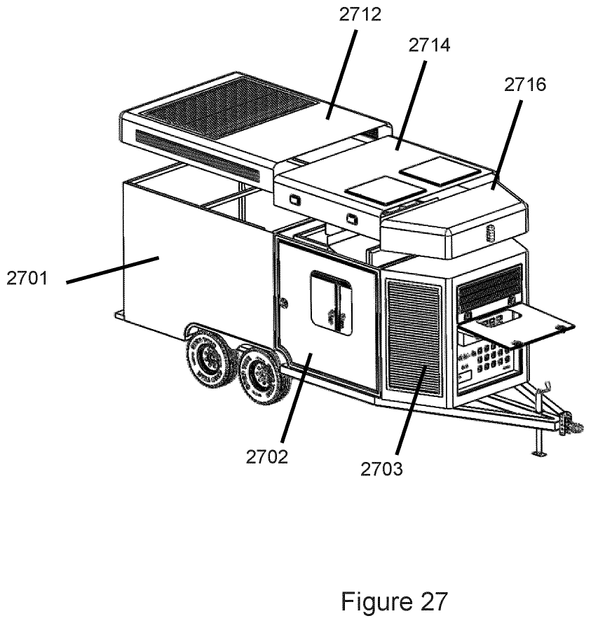

FIG. 27 illustrates multiple pieces 2712, 2714, 2716 of a vent cap, according to an embodiment. The piece 2712 is attached to a top of the fuel module 2701, the piece 2714 is attached to a top of the power module 2702, and the piece 2716 is attached to a top of the application module 2703.

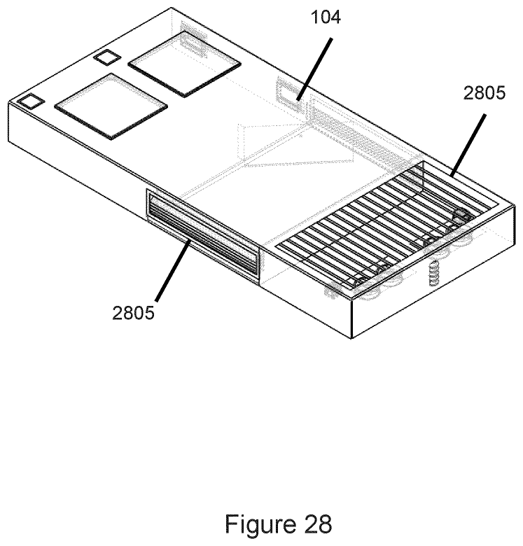

FIG. 28 illustrates a vent cap 104 according to an embodiment of the present disclosure. A variety of openings for exhausting air are shown. Each opening may exhaust air from a different, separate part of another associated module of the system.

In various embodiments, an electrical compartment of the power module is enclosed and the interior thereof is substantially sealed off from the interior of the fuel cell unit compartment of the power module. The electrical compartment interior may be kept at a positive (higher) pressure relative to the fuel cell unit compartment interior. The air inlets and air outlets for air flow streams associated with these two types of compartment may be separated. Accordingly, the electrical compartment is kept substantially free from combustible gas and may thus be non-classified as per NFPA 497 (e.g. not classified as a zone 1, zone 2 or zone 3).

Adequate protection may be provided to prevent or inhibit a build of flammable/combustible atmosphere in module (e.g. power module) interiors during normal operation. Adequate protection may be provided to shut the combustible gas supply down in response to an abnormal operation condition. In various embodiments the power module interior or electrical compartment thereof is non-classified even during abnormal operation.

In some embodiments, lifting points (e.g. ISO corners) for securing cables or other lifting devices such as ISO container lifting type devices, may be incorporated into one, some or all modules. These lifting points allow attachment of a lifting device or cable or hook thereof, providing a means of connecting to and moving each module. Modules may be separately movable from one point to another and then assembled as desired after moving. Such embodiments may facilitate providing separate components each having a manageable lifting weight for an aircraft or other lifting and/or transporting means. In some embodiments, to further facilitate transport, at least one module may be separable into multiple pieces.

In some embodiments of the invention, the fuel cell units, cooling capacity and electrical conversion devices (e.g. in power module or application module) may be singular or doubled (or more than doubled), depending on the power requirements, redundancy requirements, or both. The placement of components within the module may be performed to achieve a substantially balanced weight regardless of the components being singular or doubled.

In an embodiment of the invention, the highest mass density components are located near the bottom of a respective module to provide a low centre of gravity. Such an assembly may be useful for towing as a trailer or airlifting, such as slinging under a helicopter.

In some embodiments of the invention, the application modules are not necessarily directly attached via a transportation means, skid, or other chassis. Rather, the application modules may be attached only by electrical cables and may reside in their own enclosures.

In some embodiments of the invention, components in the power module or another module may be mounted on movable and/or slidable trays. Components in the power module may be provided in and/or framed subassemblies. Such embodiments may facilitate assembly and serviceability.

### Fuel Module as Trailer Configuration

In some embodiments, the fuel module may be a standalone trailer or component that interfaces with the remainder of the system via fuel lines and possibly electrical conductors/connectors. In one such embodiment, the fuel module may be mounted on a trailer which can be moved (e.g. driven) into or onto the mounting module, or into an associated enclosure on the mounting module and removed when required, to allow for simple refueling and replacement. Thus, a spent fuel module may be removed and replaced with a full fuel module, the spent fuel module then sent for refilling.

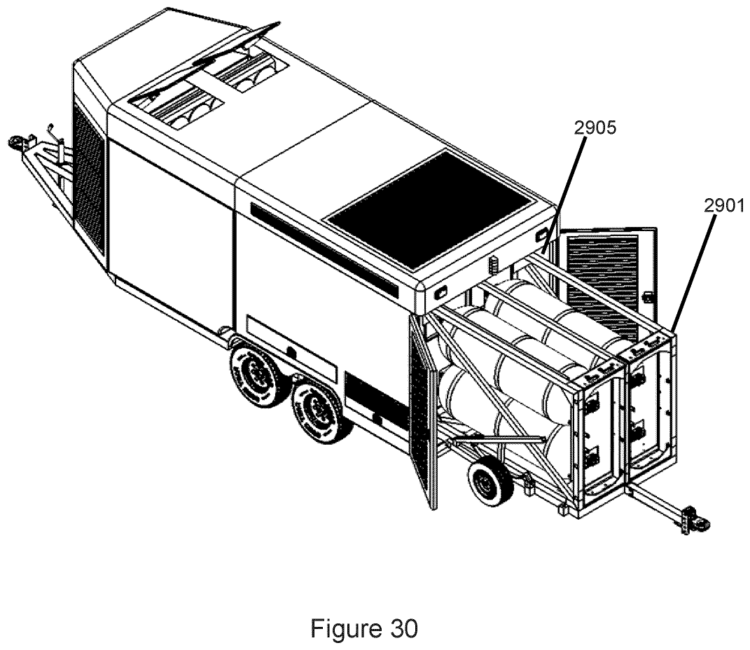

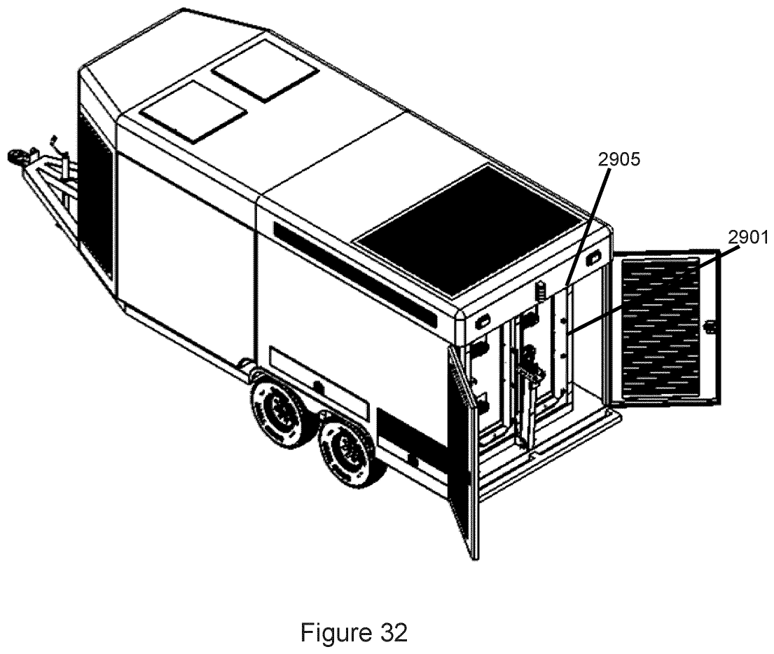

FIGS. 29 to 32 illustrate an example of such a trailerized fuel cartridge module 2901 and its use. The fuel cartridge module 2901 includes a frame 2902 within which multiple fuel cylinders 2903 are mounted. The bottom of the fuel cartridge module 2901 is configured as a trailer, i.e. with wheels and a trailer coupler. The bottom may include wheels 2904 and pivotable arms 2906 to which the wheels are attached. A spring or other resilient mechanism can urge the arms downward. The fuel module can be backed into an enclosure 2905 (fuel cartridge mounting module) as shown in FIG. 30. The trailer coupler can be removed or folded up at full insertion as shown in FIG. 32. The wheels of the fuel module can be pivotable or removable in some embodiments. For example, the wheels 2904 can be mounted to respective arms 2906 (see FIG. 29) at either side of the fuel module frame. The arms can be pivotably mounted to the frame and possibly spring-supported. When the fuel module is outside of the enclosure, the arms can extend downward so that the fuel module frame is disposed at a height which aligns it with the enclosure. When the fuel module is inserted into the enclosure, force applied from the top of the enclosure onto the fuel module frame causes a compression which, along with further horizontal motion of the fuel module during the insertion, causes the arms to pivot so that the wheels are moved upward toward the frame. Thus the wheels are lifted and moved into the enclosure along with the frame. The wheel system can be foldable for example similarly to an ambulance gurney configuration. Alternatively the fuel cartridges can be moved from their own trailer mount into the enclosure 2905 such that the fuel cartridge's independent trailer mount remains outside of the enclosure. In this and other embodiments, the enclosure for housing the fuel cylinders may be a vented enclosure.

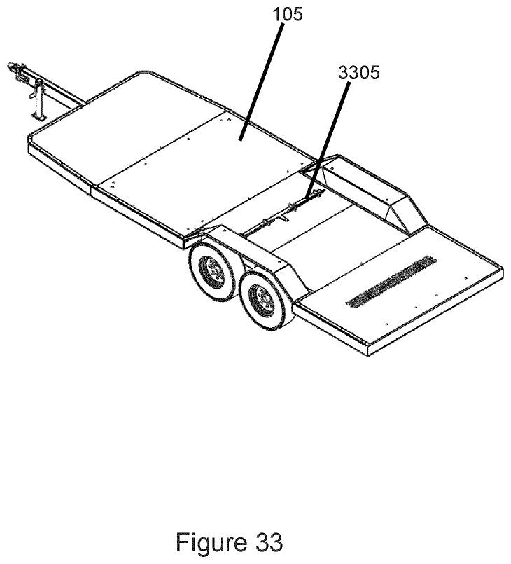

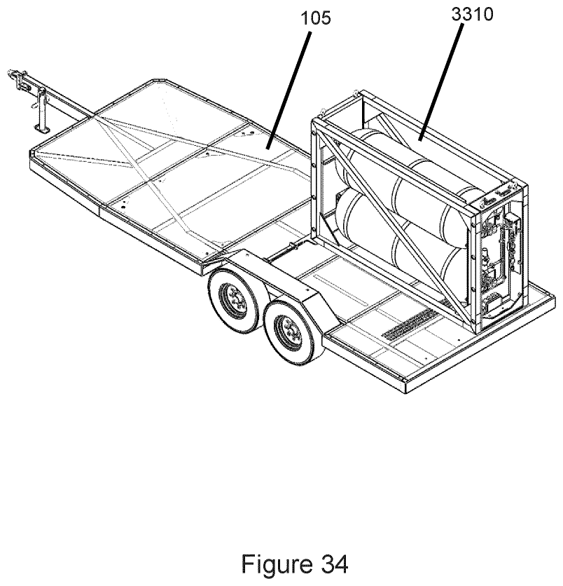

FIG. 33 illustrates a mounting module 105 as a trailer, according to an embodiment. Guides and locks 3305 are also shown. FIG. 34 illustrates the mounting module 105 of FIG. 33 with a fuel cartridge 3310 mounted thereon and locked into place.

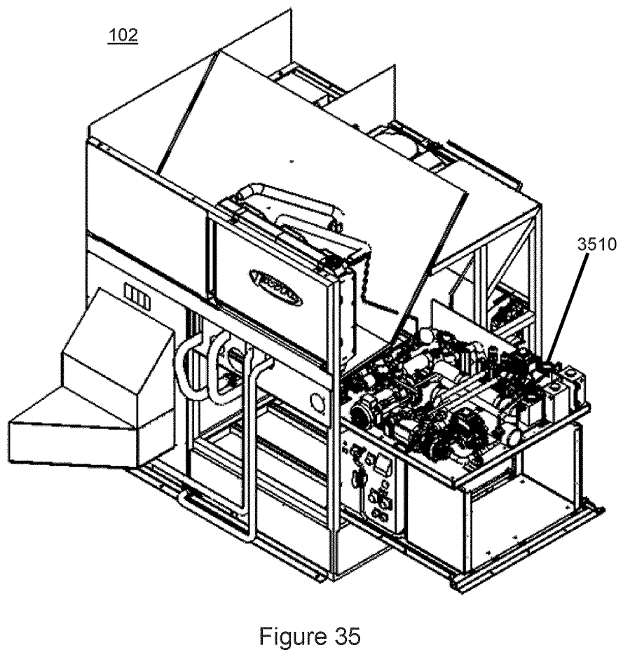

FIG. 35 illustrates a power module 102 having a fuel cell unit 3510 and balance of plant components mounted on a slide-out tray for ease of access.

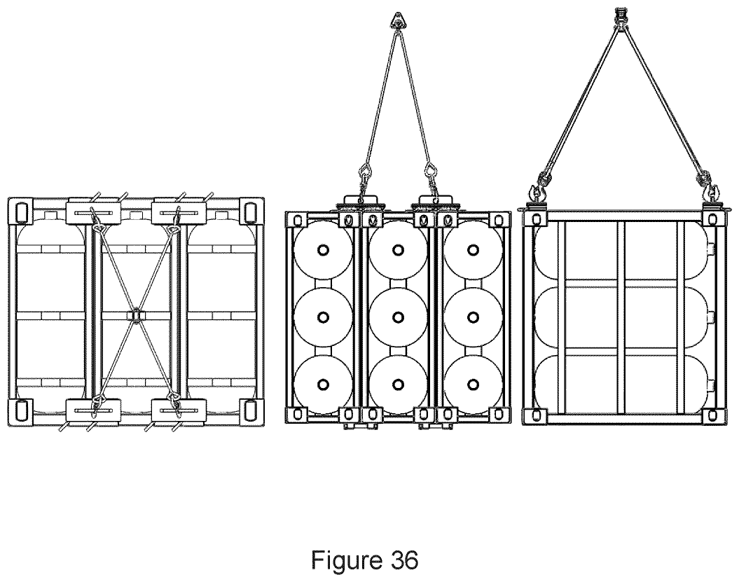

FIG. 36 illustrates a fuel cylinder layout in a frame according to an embodiment, to form a removable fuel cylinder cartridge. The fuel cylinders in this embodiment are arranged in a three-by-three grid arrangement. The fuel cylinder frame can include connection points (e.g. ISO corners) for lifting by a hoist or other device.

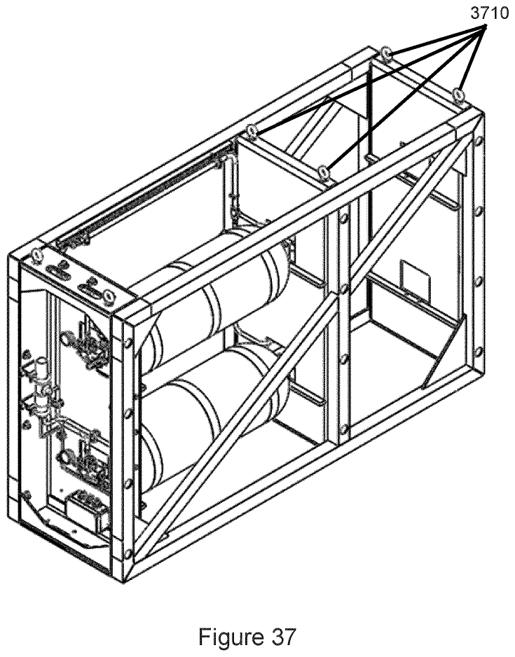

FIG. 37 illustrates a fuel cylinder cartridge with lifting connection points 3710, according to an embodiment.

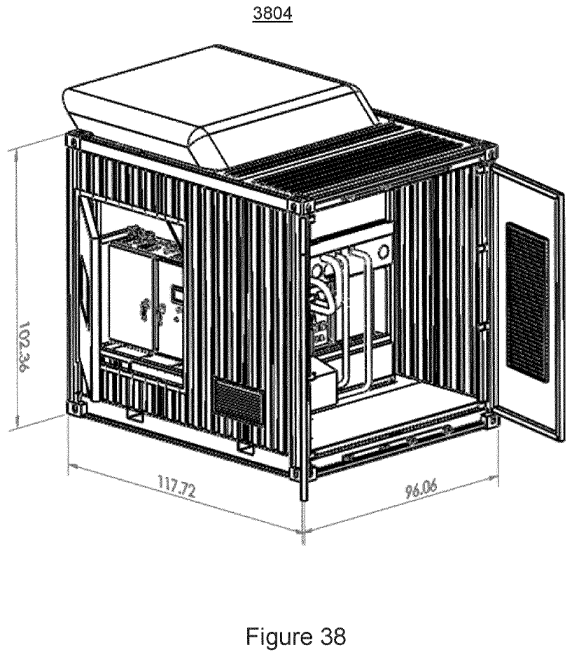

In some embodiments, the application module is not necessarily physically coupled to one or more other modules. Rather, the application module (or another module) may be provided in a stand-alone configuration. FIG. 38 illustrates a standalone and containerized power generating device or power module 3804 according to an embodiment. The power module can be operatively coupled to other modules, such as the application module, via cables, flexible or rigid piping, etc.

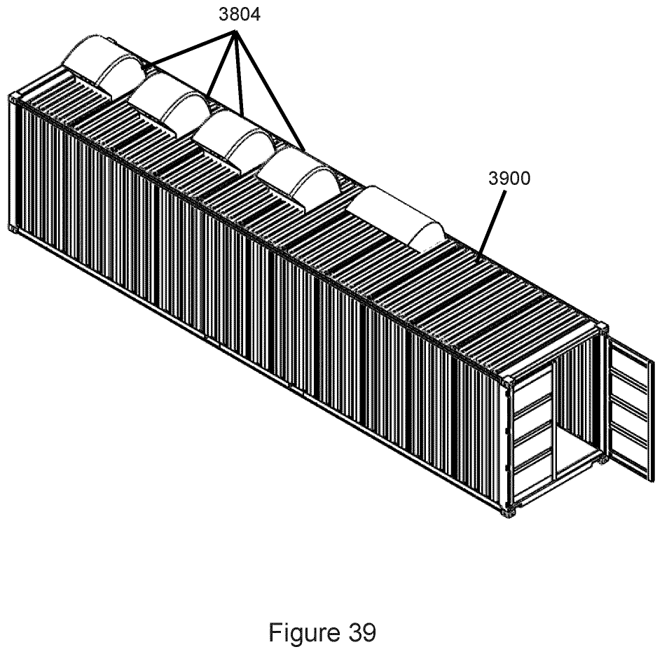

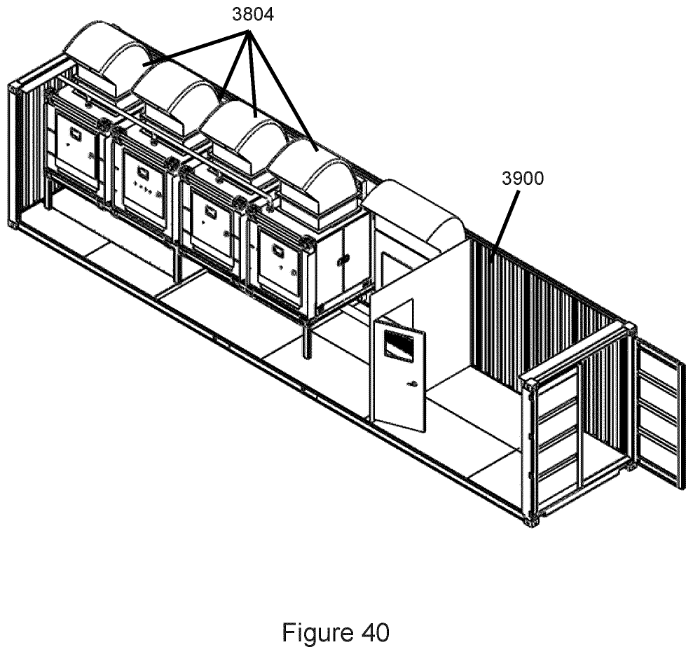

FIG. 39 illustrates a container 3900, such as a shipping container or sea can, adapted to include one, two or more power generating devices or power modules 3804, according to an embodiment. FIG. 40 illustrates the same container as FIG. 39, in cutaway view.

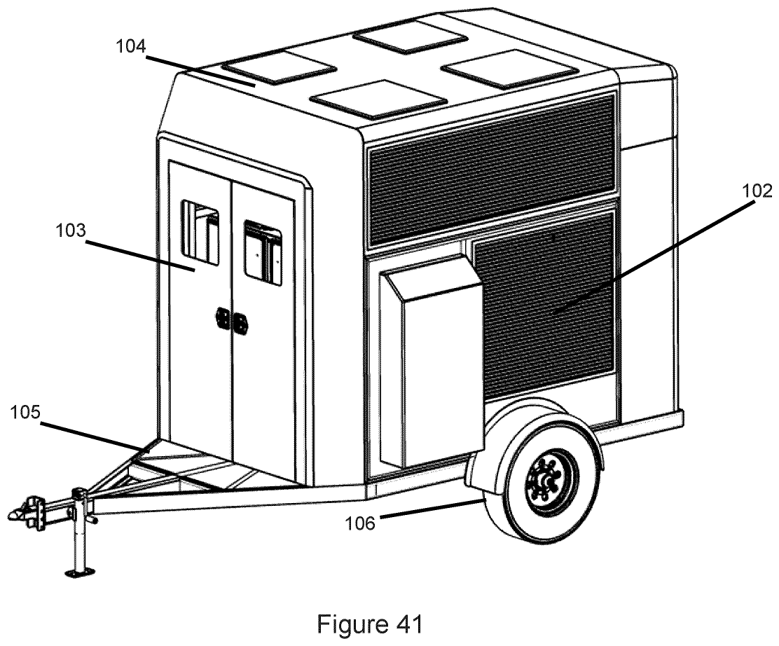

FIG. 41 illustrates a trailerized, portable power generating device in which a fuel module is separate or excluded. The device includes a power module 102 and an application module 103, as well as a cooling and venting module 104 and mounting module 105 with transport portion 106. In addition, the power module and the application module may be integrated together. Rather than a fuel module being part of the device, a separate fuel source, e.g. on another trailer or in separate tanks, can be provided. The fuel source can be connected to the device via rigid or flexible piping.

In addition to or alternatively to the above, embodiments of the present invention provide for a standardized-component platform providing a (e.g. zero-emission) power unit with fuel (e.g. hydrogen) storage. A power module and fuel module can be stackable with one another, optionally on a mounting module for portability. The components can be rearranged to provide one or more of: a power unit with on-board fuel storage, an auxiliary fuel source (storage system), and a fuel delivery system. In the following, the term “second module” is used as a generalization of a power module. The second module typically includes a power module but may also include other modules such as an application module. The second module can thus include multiple sub-modules in one of a variety of physical relationships, and the sub-modules may be separable or integrated more or less permanently together. Additionally or alternatively, an application module can be separate, for example a stand-alone unit connected to the power module via electrical cabling. The second module may consist or consist essentially of the power module. In some embodiments, the power module may be used in applications requiring between 50 kW and 200 kW of power. In some embodiments the power module and fuel storage may scale to higher power and fuel storage capabilities when using a larger trailer or mounting module.

Embodiments thus provide for a removable, exchangeable and/or stackable fuel module in association with one or more other modules, which may also be removable, exchangeable and/or stackable. The fuel module and/or other modules can be standardized in their size, footprint, attachment configuration, etc. so that they can be readily interchanged with other modules of the same or different type. Thus, there is provided a platform that provides standardized components that are useful for onboard fuel for the power unit, auxiliary fuel for the power unit, and for bulk fuel transport which provides for fuel availability for the power unit, as is required from time to time. This is in contrast to other solutions in which fuel storage is not removable or exchangeable, and is not used for auxiliary fuel or fuel delivery.

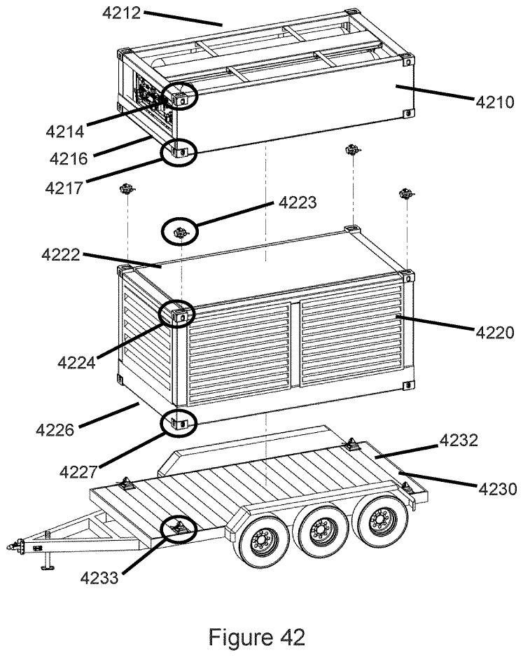

FIG. 42 illustrates, in exploded view, a fuel module 4210 disposed on top of a second module 4220, which in turn is disposed on top of a mounting module 4230 in the form of a wheeled platform such as a trailer. The mounting module may alternatively lack wheels. For example the mounting module may be a skid with an upper deck as illustrated. The fuel module houses one or more compressed cylinders containing combustible gas. The second module is configured to receive the combustible gas from the fuel module, e.g. via suitable hoses, and to generate electrical power using the combustible gas. Because the fuel module is on top of the second module, leaked lighter-than-air fuel, such as hydrogen, will escape upward and not intrude into the second module which may present a risk of combustion. Furthermore, any leakage of such fuel from the second module will escape around or through the fuel module, which does not have any ignition sources. Thus, FIG. 42 provides for a portable power unit with on-board fuel storage.

The fuel module has an upper surface 4212 and a lower surface 4216. The second module similarly has an upper surface 4222 and a lower surface 4226. The mounting module similarly has an upper surface 4232. The upper surfaces 4212, 4222, 4232 and the lower surfaces 4216,4226 are all substantially the same size and shape, to facilitate stackability. This size and shape is an aspect of an attachment footprint associated with each such surface. Furthermore, each upper surface 4212, 4222, 4232 and each lower surface 4216, 4226 has, in certain locations in the horizontal plane (e.g. at or near corners thereof), attachment devices or apertures, protrusions or other features for connecting to attachment devices. As shown, this includes apertures 4214, 4217, 4224, 4227 and attachment devices 4223, 4233. The attachment devices are configured to matingly connect together the upper surface of one module with the lower surface of an adjacent module. These attachment devices or associated features are arranged at certain locations to align with corresponding attachment devices or associated features of other modules, and this arrangement is another aspect of an attachment footprint associated with each surface.

For more certainty, the fuel module upper surface 4212 is associated with a first attachment footprint, the second module upper surface 4222 is associated with a second attachment footprint, the fuel module lower surface 4216 is associated with a third attachment footprint, the mounting module upper surface 4232 is associated with a fourth attachment footprint and the second module lower surface 4226 is associated with a fifth attachment footprint. Multiple fuel modules, if present, can be substantially similar or identical to one another. The first and second attachment footprint are configured for mating attachment with the third attachment footprint. This allows a fuel module to be selectably stacked either on another fuel module or, in an alternative configuration on the second module. Thus, a reconfigurability feature is provided. The fourth attachment footprint is configured for mating attachment with the third attachment footprint and the fifth attachment footprint. This allows the mounting module to directly support either a fuel module or a second module. In some embodiments, for example when the mounting module is not present, the second module may optionally omit the attachment footprint associated with its lower surface.

There are a variety of ways to provide for mating attachment of module surfaces with one another. FIG. 42 illustrates an approach by which each module upper and lower surface contains apertures for coupling to attachment devices, or alternatively attachment devices themselves, at locations aligned to facilitate mating attachment with adjacent modules. The locations, type, presence and configuration of the apertures and/or attachment devices may be part of the attachment footprint. The apertures can be ISO corners as used for example in standard shipping containers, and the attachment devices can be ISO corner twist locks or similar devices. Some aspects of twist locks are described herein for completeness, however different twist locks or similar devices can be employed as will be readily understood by a worker skilled in the art.

In some embodiments, the first, second and fourth attachment footprints (on the upper surfaces of respective modules) are substantially the same as one another, and each is configured for mating attachment with any one of the third and fifth attachment footprints (on the lower surfaces of respective modules), where the third and fifth attachment footprints are also substantially the same as one another. In some embodiments, some or all of the attachment footprints are substantially the same (e.g. ISO corners having the same position and spacing). However, due to the presence of removable attachment devices, different interchangeable means of attachment (e.g. removable or integrated twist locks), and other features, it is more suitable to state which attachment footprints are configured for mating attachment with one another. In this respect, attachment footprints on upper surfaces (e.g. first, second and fourth attachment footprints) are generally configured for mating attachment with any one of the attachment footprints on lower surfaces (e.g. third and fifth attachment footprints).

In the approach of FIG. 42 and related drawings, the mounting module upper surface 4232 includes four attachment devices 4233 (e.g. ISO corner twist locks) which have protrusions configured to enter apertures 4227 (e.g. of ISO corners) on the second module lower surface 4226 or alternatively apertures 4217 the fuel module lower surface 4216. The protrusions are of the twist-lock type, i.e. with a section that can be rotated to lock them into place once within the apertures. The second module upper surface 4222 can include similar attachment devices with a same or similar footprint. For example, as illustrated, the second module upper surface 4222 has apertures 4224 in a same relative location as the attachment devices 4233 on the mounting module upper surface 4232, for coupling to attachment devices 4223. The attachment devices can be removable or non-removable. Removable attachment devices can be double-headed ISO corner twist locks, or two ISO corner twist locks arranged back-to-back, or similar. In some embodiments, and as illustrated the attachment devices 4223 for the second module are removable, but the attachment devices on the mounting module are non-removable. Coupling of removable attachment devices to the upper surface of a module can be by substantially the same mechanism as coupling of the removable attachment devices to the lower surface of a module. For example, the attachment devices can be coupled to the upper surface 4222 via a twist-lock action. Similar devices 4223 can be coupled to the fuel module upper surface 4212. The fuel module 4210 has apertures 4214 on its upper surface 4212, with a similar layout to the apertures 4224 on the upper surface 4222 of the second module 4220. The fuel module and second module upper and lower surfaces can all be supplied with ISO corners for mating with attachment devices. The ISO corners can also facilitate handling of the modules, for example by providing points of connection for a hoisting device.

Accordingly there is provided a solution that standardizes a power module, fuel module and optional mounting module (e.g. trailer), such that the modules all have, in the horizontal dimension (XY plane), a common and compatible layout of connecting and securing location(s) for securing mechanisms to attach the modules to one another. The securing mechanisms may be separate or integrated and may take the form of twist locks and ISO corners, as one example. The securing locations may be on each side, top and bottom. Thus the modules can be connected together in differing assemblies for different purposes, for example as a generator with onboard fuel, as an auxiliary fuel source, and as a fuel transport and delivery trailer.

The fuel module may incorporate a vented enclosure. For example, as illustrated, the fuel module 4210 has an open top and front side, i.e. with limited or minimal covering. The fuel module may similarly have an open bottom and back side, and may also have open other sides. Beams or other structures are still present along the edges of the fuel module to provide sufficient support for a stackable structure. Such an open configuration allows for any leaked gas such as hydrogen gas to escape into the environment via a substantially uninhibited path, to quickly escape upward and away from ignition sources. By having both open bottom and top, leaked gas from lower modules, such as the second module or other fuel modules, can pass upward through the fuel module for escape. Such a configuration mitigates potential for hazardous gas buildup or explosion. Active fans may be provided to facilitate airflow in such embodiments, but may not be necessary. The fuel cylinders may be stacked horizontally side by size within the fuel module, in one, two or more layers.

A further potential advantage of having the fuel module (also referred to as a fuel storage module, fuel unit or fuel storage unit) on top of the second module (also referred to as a power module or power unit) is that the fuel module can be lifted off of or mounted onto the second module by using a lifting and lowering device such as a hi-hab, crane or forklift. This allows for replacement of fuel modules in situations where refueling via a fuel delivery truck is not possible, such as in remote locations that are not readily accessible by vehicle and may require delivery by another transport means, such as a helicopter or boat.

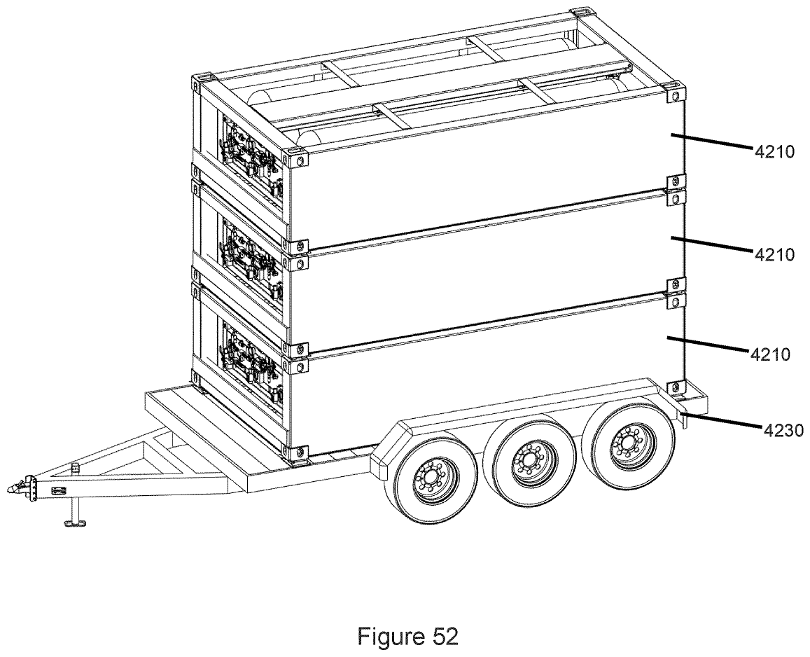

A further potential advantage of having the fuel module on top of the second module is the mounting module (trailer) dimensions can be standardized to the horizontal plane securing locations of the second module and fuel module, as they are aligned and common to each other and provide for the fuel module to be stacked on the trailer for use as an auxiliary fuel source or for transportation of fuel. Thus, the same mounting module can be used for both the system of FIG. 42 and the system of FIG. 52, for example.

In some embodiments, the fuel module may be adapted to house removable fuel cylinders, or cartridges containing one or more fuel cylinders, as described elsewhere herein. The fuel module may be similar to the fuel cylinder cartridge of FIG. 37, or may contain such a fuel cylinder cartridge.

The second module 4220 includes a power module which may have aspects as described elsewhere herein. For example, the power module may have a configuration generally as described with respect to FIG. 9 or 10. The power module may have multiple separated airflows for example as described with respect to FIG. 25 or 26. The second module may include a vent cap as an integrated or separable component. The second module may be configured so that exhaust air exits from the top or sides, or a combination thereof.

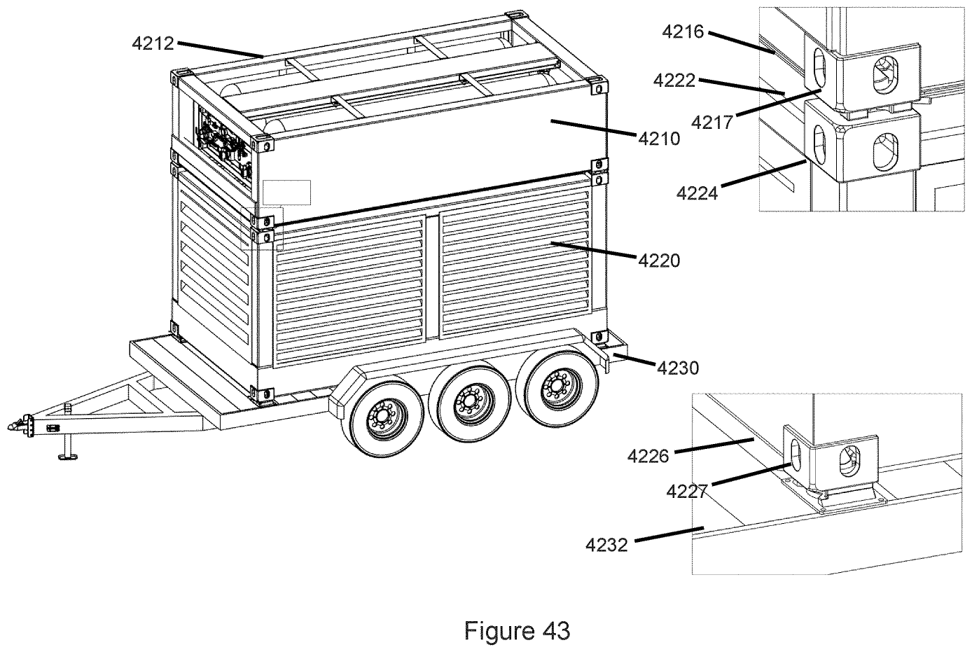

FIG. 43 illustrates the system of FIG. 42 after assembly. A mating pair of ISO corners of adjacent attachment footprints, of second module upper surface 4222 and fuel module lower surface 4216 is also shown in detail. The fuel module 4210 can be removed by disengaging the attachment devices and lifting the fuel module off of the second module 4220. This can be performed when the fuel module has run out of fuel, to exchange it with another fuel module (with identical attachment footprint on its lower surface 4216) which can be provided and attached to the second module in place of the spent fuel module. In this way, refueling can occur.

FIG. 43 also illustrates in detail an adjacent pair of ISO corners forming parts of the attachment footprints of the fuel module lower surface and the second module upper surface. FIG. 43 also illustrates in detail an ISO corner forming part of the attachment footprint of the second module lower surface, adjacent to the mounting module upper surface.

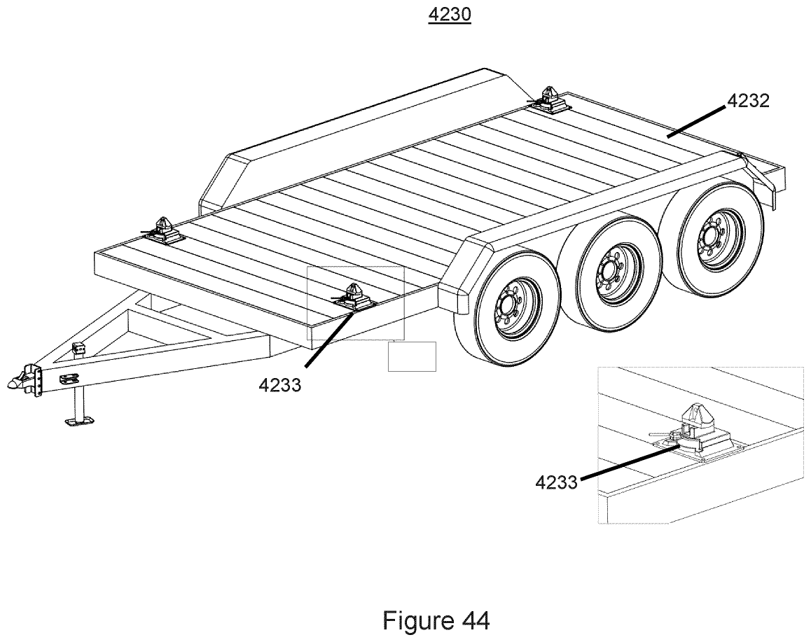

FIG. 44 illustrates the mounting module 4230 in more detail, including a more detailed view of a twist lock attachment device 4233 on the upper surface 4232 of the mounting module and forming part of the attachment footprint thereof.

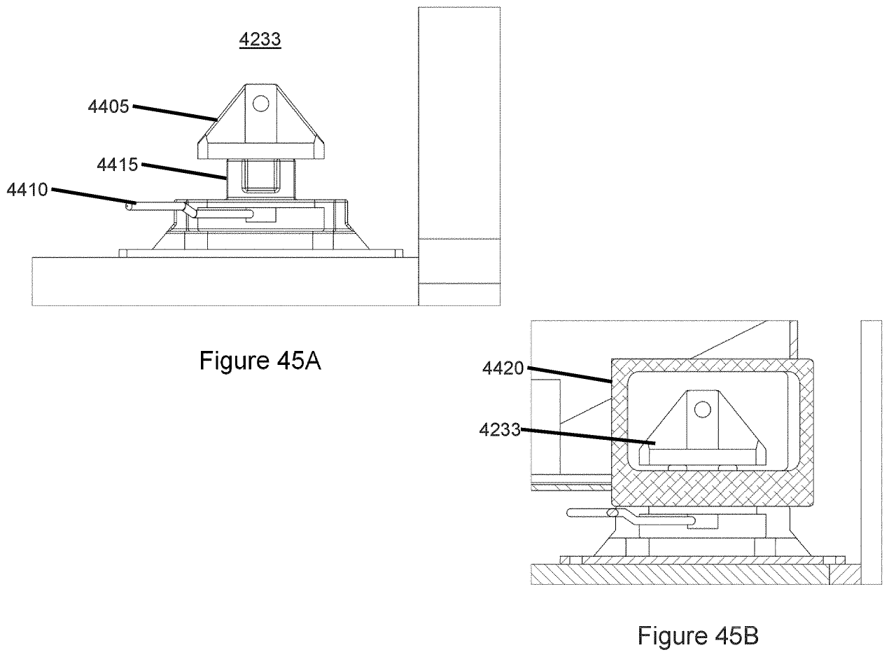

FIG. 45A illustrates the twist lock attachment device 4233 in more detail. A tapered securing head 4405 is visible and is pivotable by applying force to an arm 4410. The securing head 4405 is disposed on top of a narrower portion 4415. The securing head and narrowing portion enter a rectangular aperture of an ISO corner so that the securing head reaches a wider cavity within an interior of the ISO corner. Then, the securing head is pivoted so that it cannot be removed through the same rectangular aperture due to its orientation. FIG. 45B illustrates the twist lock attachment device 4233 inserted into an aperture of an ISO corner 4420.

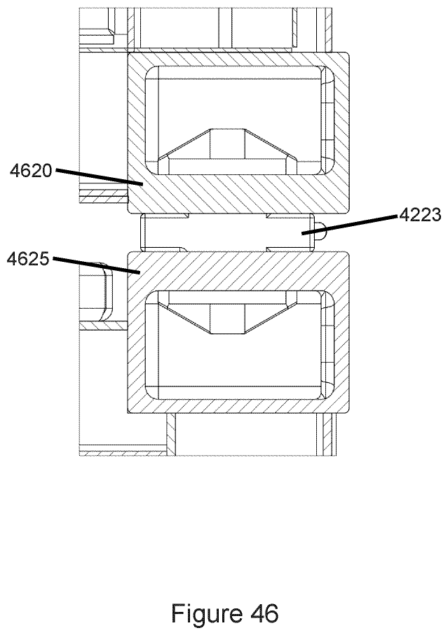

FIG. 46 illustrates a double-headed twist lock attachment device 4223, mated with two adjacent ISO corners 4620, 4625 to hold together two adjacent modules. The twist lock attachment device 4223 operates on a similar principle to that device 4233 of FIG. 45, but each of two similar but opposite portions operates on a respective one of two ISO corners 4620, 4625.

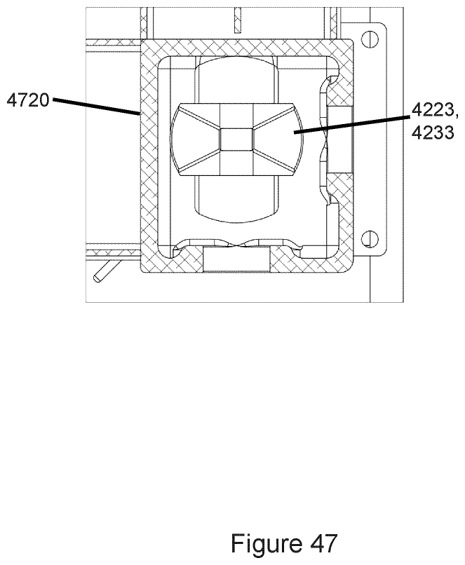

FIG. 47 illustrates a top view of the twist lock attachment device 4223 or 4233, showing the attachment device engaged in a locked position with an ISO corner 4720.

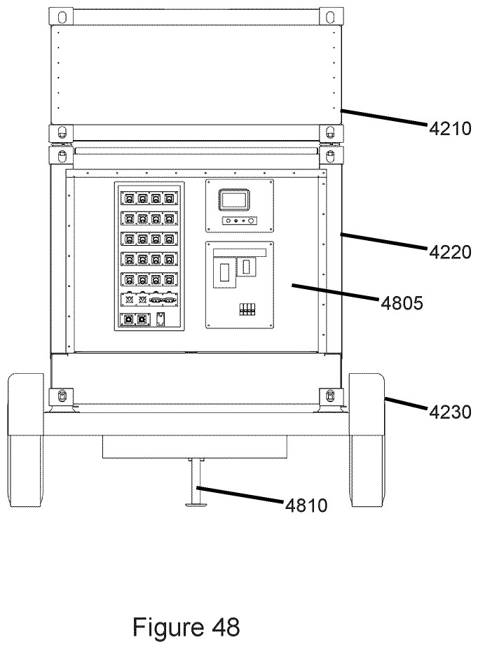

FIG. 48 illustrates an end view of a system such as that in FIGS. 42 and 43 in one embodiment, such that an application module, control panel, or both, are present as shown as feature 4805. The application module can thus be integrated into the second module 4220, which also includes the power module. A retractable or removable support 4810 is also shown, which may be adjacent to the trailer hitch. In some embodiments, the application module of any one of FIGS. 14 to 24, or another application module, can be integrated into the second module 4220 or provided as an additional module for coupling to the second module.

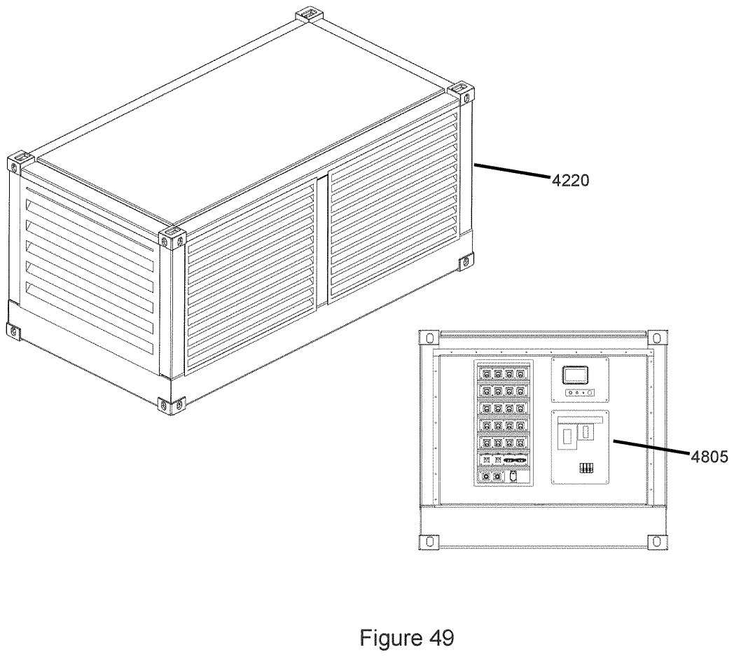

FIG. 49 illustrates another view of the second module 4220, which may be provided as a stand-alone unit or with a fuel module stacked on top. The application module and/or control panel feature 4805 is shown, and may be located behind a cover. The side panels of the second module 4220 are provided with vents or louvers to facilitate air flow for cooling, venting (e.g. of potential leaked gas), or the like.

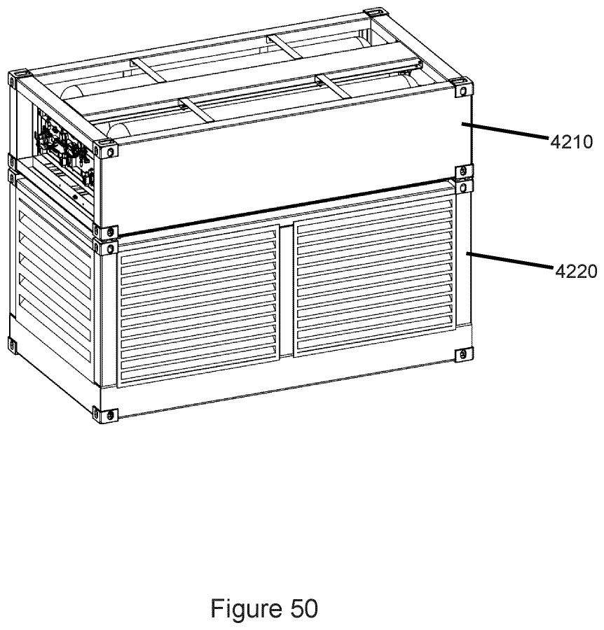

FIG. 50 illustrates the second module 4220 with fuel module 4210 disposed thereon. The mounting module is absent. For example, the illustrated system can be installed on ground, another module, or another support bearing where portability is less of a priority.

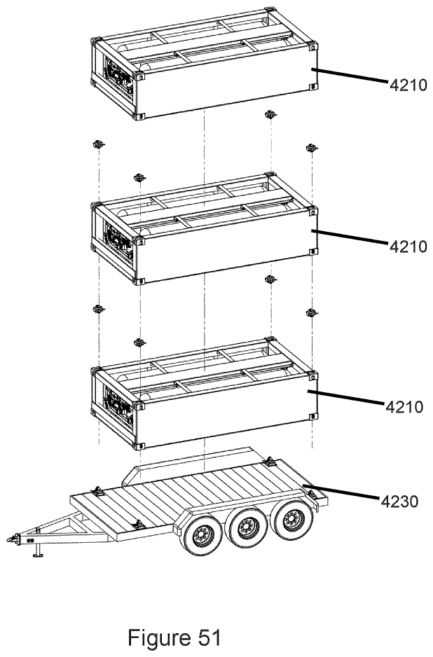

FIG. 51 illustrates, in exploded view, three different fuel modules 4210 disposed on top of one another, and in turn being disposed on top of a mounting module 4230. A similar attachment system as was already described above, comprising twist locks and ISO corners, is used to secure the fuel modules 4210 together and to the mounting module 4230. The assembled system provides for a portable (e.g. trailerized) auxiliary fuel source or portable (e.g. trailerized) fuel delivery system.

FIG. 52 illustrates the system of FIG. 51 after assembly. In some embodiments, the height of the system of FIG. 52 is the same, or approximately the same, as the height of the system of FIG. 43. This can be achieved by having the fuel module 4210 be half the height of the second module 4220. This in turn can provide a uniformity of dimensions of the two different system configurations to facilitate transportation, deployment, storage, etc. Other arrangements resulting in N stacked fuel modules having the same or approximately the same height as a system of L fuel modules stacked on top of M second modules can be similarly achieved, for example by configuring the second module height to be (N−L)/M times the fuel module height. When M=1 for example this means the second module height is (or is approximately) some integer multiple of the fuel module height. In the illustrated example, the second module is (or is approximately) twice the height of the fuel module.

The stacked fuel modules 4210 can thus be mounted on a trailer and transported as an auxiliary fuel trailer to be connected, e.g. via a fuel hose to a nearby power module (e.g. of FIG. 42) either directly or through an onboard fuel module stacked onto the power module/second module. Such an assembly can also be used as a refueling trailer to refuel another fuel module or can be used to deliver one or more fuel modules for replacement of another fuel module.

In some embodiments, one, some or all of the fuel modules 4210 may incorporate a trailerized fuel cartridge such as is illustrated in FIGS. 29 and 30. In some embodiments, the system of FIG. 52 can be configured as such a trailerized fuel cartridge for use with another enclosure.

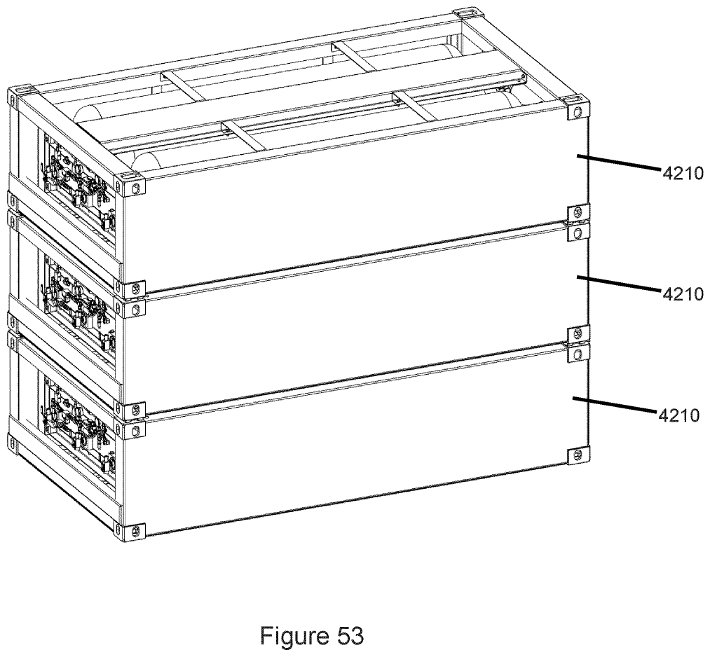

FIG. 53 illustrates three stacked fuel modules 4210 with mounting module absent. For example, the illustrated system can be installed on ground, another module, or another support bearing where portability is less of a priority, to provide for an auxiliary fuel source.

It is noted that a same collection of modules can be rearranged in a variety of ways due to their compatible mating attachment footprints. For example, in a first arrangement, the fuel module can be mounted directly to the second module, and the second module can be mounted (directly or indirectly) to the mounting module, as in FIG. 43, to provide a generator with onboard fuel. In another alternative arrangement, the same fuel module can be mounted on another fuel module, and the other fuel module can be mounted to the same mounting module, as in FIG. 52, to provide an auxiliary fuel source or fuel delivery trailer. In other arrangements, the mounting module can be omitted, as in FIGS. 50 and 53, for example to provide a stationary generator with onboard fuel, or a stationary fuel source. Multiple different modules of the same type, e.g. fuel modules, can be interchanged with one another due to their same attachment footprints. Due to the mating attachments being removable, such rearrangements can occur as needed and repeatedly.

Embodiments of the present invention are described primarily with respect to the use of hydrogen gas to generate electricity using a hydrogen fuel cell (non-combustion) approach. However, in other embodiments, the hydrogen gas is used as a fuel source which is combusted, for example using an internal combustion-based electrical generator. In yet other embodiments, another type of lighter-than-air gas, which is typically combustible at least under certain conditions, is used as a fuel source which is combusted, again for example using an internal combustion-based electrical generator. In such embodiments, gas may be combusted (e.g. after mixing with oxygen) to generate kinetic energy, and the kinetic energy may be converted into electricity. This can be achieved using a conventional gas-powered electrical generator, an alternator, etc. If another form of energy, other than electricity, is required, then the internal combustion engine may be configured to directly or indirectly provide that form of energy.

In embodiments using internal combustion, a fuel cell as described herein can be replaced with the combustion-based (gas-powered) electrical generator. The placement of the electrical generator may be different from the fuel cell, however the electrical generator may be generally located within the power module. Air flows may be used to service the electrical generator for example for cooling and exhaust purposes. Gaseous exhaust may also be carried away by dedicated or non-dedicated air flows. The apparatus may further be configured to accommodate vibrations due to moving parts of such an electrical generator.

Although the present invention has been described with reference to specific features and embodiments thereof, it is evident that various modifications and combinations can be made thereto without departing from the invention. In particular, values specified herein and provided as examples may be modified in a variety of ways. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1-44. (canceled)

45. A system for providing a resource using a combustible gas, the system comprising:
a fuel module housing one or more compressed cylinders containing the combustible gas;
a second one or more modules configured to receive the combustible gas from the fuel module and generate electrical power using the combustible gas and to provide one or more useful outputs using said electrical power provided,
wherein the second one or more modules includes a power module configured to generate the electrical power and an application module configured to provide the one or more useful outputs, and
wherein the fuel module is disposed on top of the second one or more modules and the combustible gas is lighter than air.

46. The system of claim 45, further comprising a mounting module, wherein the fuel module has a same mounting and attachment footprint as the second one or more modules, taken either separately or together, so that different stacking arrangements are possible.

47. The system of claim 45, further comprising a mounting module, the fuel module, the power module and the application module being affixed to and supported by the mounting module.

48. The system of claim 47, wherein the mounting module is adapted as a trailer for transportation.

49. The system of claim 45, further comprising a cooling and venting module operatively coupled to one or more of the fuel module, the power module and the application module and configured to cause air to flow through said one or more of the fuel module, the power module and the application module.

50. The system of claim 45, wherein the fuel module comprises one or more removable and exchangeable cartridges, each having one or more of said compressed hydrogen gas cylinders.

51. The system of claim 45, further comprising one or more additional application modules, wherein the application module and each of the additional application modules are interchangeable with one another so that one of the application module and the additional application modules is operatively coupled to the power module at a time, and other ones of the application module and the additional application modules is decoupled from the power module at said time, the application module and at least one of the additional application modules being of different types.

52. The system of claim 51, wherein said different types include two or more of: an application module adapted to distribute electrical power optimized for a first use; an application module adapted to distributed electrical power optimized for a second use different from said first use; an application module operating as a gas compressor; an application module adapted to dispense hydrogen gas; an application module configured to perform water purification; an application module configured to provide lighting; an application module configured as a charging station; and an application module adapted to provide two or more functions.

53. The system of claim 45, wherein the application module is configured as a charging station for charging vehicles, the application module having one or more articulating or extendable arms having charging ports mounted thereto.

54. The system of claim 45, wherein one or more of the fuel module, the power module and the application module are separately transportable.

55. The system of claim 45, wherein each of the one or more compressed gas cylinders has a respective gas outlet, each of said respective gas outlets being located at a rearmost part of the system.

56. The system of claim 45, wherein the power module is configured to cause two or more physically separate air flow streams therein, each of the two or more physically separate air flow streams providing component cooling, combustible gas venting, or a combination thereof, for a different respective portion of an interior of the power module.

57. The system of claim 56, further comprising a cooling and venting module, wherein the cooling and venting module is configured to force air through some or all of the two or more physically separate air flow streams.

58. The system of claim 56, wherein a first one of the physically separate air flow streams has a higher potential for containing a portion of the combustible gas than a second one of the physically separate air flow streams, said first one of the physically separate air flow streams being located above said second one of the physically separate air flow streams.

59. The system of claim 56, wherein each of the physically separate air flow streams is directed generally upward from an air inlet to an air outlet.

60. The system of claim 45, wherein the combustible gas is hydrogen, natural gas, or methane.

61. The system of claim 45, wherein the combustible gas is hydrogen, and wherein the power module includes one or more hydrogen fuel cells for generating said electrical power.

62. A system for providing a resource using a combustible gas, the system comprising:
a fuel module housing one or more compressed cylinders containing the combustible gas;
a second one or more modules configured to receive the combustible gas from the fuel module and generate electrical power using the combustible gas and to provide one or more useful outputs using said electrical power provided,
wherein the fuel module comprises one or more removable and exchangeable cartridges, each having one or more of said compressed hydrogen gas cylinders, and
wherein at least one of the one or more cartridges has a pair of beveled bottom sides, and wherein gas conduits are routed along one of the beveled bottom sides and electrical cables are routed along another one of the beveled bottom sides.

63. The system of claim 62, wherein at least one of the one or more cartridges is mounted on a set of wheels.

64. The system of claim 63, wherein said at least one of the one or more cartridges is adapted for transportation as a trailer.
